(19) United States
(12) Patent Application Publication
(10) Pub. No.: US 2011/0031368 A1
(43) Pub. Date: Feb. 10, 2011

(54) Hanger assembly for ceiling fan

(75) Inventor: Cliff Wang, Taichung City (TW)

Correspondence Address: MICHAEL WINFIELD GOLTRY, 4000 N. CENTRAL AVENUE, SUITE 1220, PHOENIX, AZ, 85012, US

(73) Assignee: AIR COOL INDUSTRIAL CO., LTD, TAICHUNG CITY (CN)

(21) Appl. No.: 12/726,607

(22) Filed: Mar. 18, 2010

Related U.S. Application Data
(63) Continuation-in-part of application No. 12/537,734, filed on Aug. 7, 2009.

(51) Int. Cl. F16M 13/02

(52) U.S. Cl. 248/343; 248/342

(57) ABSTRACT

A hanger assembly for depending a ceiling fan from an overhead includes a hanger bracket securable to an overhead support. A down rod suspended from the hanger bracket has a lower end adapted for engagement with the ceiling fan. A canopy has a central opening through which the down rod is received and an upper rim which receives the hanger bracket. The upper rim of the canopy is secured to the hanger bracket by a plurality of screws having heads exposed on the outside of the upper rim of the canopy. A rim cover which fits over and encapsulates the screw heads is engagable with upper rim of the canopy.

### FIELD OF THE INVENTION

This invention relates to ceiling fans.

More particularly, the present invention relates to hanger assemblies for depending a ceiling fan from an overhead support device. In a further and more specific aspect, the instant invention concerns an aesthetically enhanced hanger bracket of the above type.

### BACKGROUND OF THE INVENTION

Ceiling fans are conventionally suspended from a ceiling by means of a hanger assembly. A known hanger assembly includes a hanger bracket securable to an overhead support member such as an electrical junction box. The hanger bracket includes slots which receive screws there through for engagement with the flanges of the junction box.

A ball socket is formed into the top of the hanger bracket. A ball, supported in the ball socket for swivel motion, supports a depending down rod. Attachment means, integral with the lower end of the down rod, are secured to the fan. A canopy, generally in the shape of an inverted dome, includes a central opening through which the down rod passes and an upper rim which encircles the peripheral sidewall of the hanger bracket.

The rim of the canopy is secured to the hanger bracket by means of a plurality of screws which extend through openings in the rim of the canopy and threadedly engage within the hanger bracket. The heads of the screws reside external of the canopy.

It is recognized that the exposed screw heads detract from the aesthetics of the hanger assembly. Accordingly, the prior art has provided a rim cover which encapsulates the screw heads. In accordance with one embodiment, the prior art has provided a rim cover having a plurality of J-shaped recesses formed into the inside surface which receive the heads of the screws. In accordance with another embodiment, the rim cover is fabricated of a resilient material. An annular groove formed in the inner surface of the resilient cover receives the screw heads in snap engagement.

While encasing the screw heads, the rim covers provided by the prior art have not proven to be entirely satisfactory. Forming a J-shaped groove into the inner surface of the rim cover requires that the rim cover be extraordinarily thick. Also forming such grooves requires extraneous and relatively expensive manufacturing. Fabricating the rim cover of a resilient material detracts from the desired aesthetics. It is also noted that the screw heads tend to be relatively small with rounded exposed surfaces which do not adequately engage the prior art rim covers.

It would be highly advantageous, therefore, to remedy the foregoing and other deficiencies inherent in the prior art.

### SUMMARY OF THE INVENTION

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, mounting screws each extending through the rim of the canopy and engaged to the hanger bracket and having a head residing external of the rim of the canopy, and a rim cover for encapsulating the heads of the screws and securable with respect to the rim of the canopy. The rim cover has opposed fingers each having a lower end affixed to the rim cover and an opposing upper end, a notch between the opposed upper and lower ends, and opposed front and rear faces. There is a first gap between the opposed fingers extending from and between the upper ends of the fingers and the lower ends of the fingers, and a second gap between the rear faces of the fingers and the rim cover. The fingers are flexurally resilient in reciprocal directions relative to each other to admit the head of one of the screws into the first gap and into the notches formed in the fingers to embrace and secure the head of the screw. The fingers are also flexurally resilient in reciprocal directions relative to the rim cover. The rim cover includes an upper edge receivable in juxtaposition with the ceiling. The rim cover also includes an in turned lower edge receivable in juxtaposition with the canopy.

According to the principle of the invention, a hanger assembly for depending a fan from an overhead support includes a mounting bracket securable to the overhead support; a down rod to be suspended from the mounting bracket and having a lower end engagable with the fan; a canopy having a central opening for receiving the down rod there through and having an upper rim, mounting screws each extending through the rim of the canopy and engaged to the hanger bracket and including a head residing external of the rim of the canopy, and a rim cover for encapsulating the heads of the screws and securable with respect to the rim of the canopy. The rim cover has opposed fingers each having a lower end affixed to the rim cover and an opposing upper end, a notch between the opposed upper and lower ends, and opposed front and rear faces. There is a gap between the rear face of each of the fingers and the rim cover. The fingers are flexurally resilient to admit the heads of the screws into the notches of the respective fingers to embrace and secure the heads of the screws. The fingers are also flexurally resilient in reciprocal directions relative to the rim cover. The rim cover includes an upper edge receivable in juxtaposition with the ceiling. The rim cover also includes an in turned lower edge receivable in juxtaposition with the canopy.

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, and opposed mounting screws each extending through the rim of the canopy and engaged to the hanger bracket and including a head residing external of the rim of the canopy. The heads of the screws each have a side. Further to the hanger assembly is a rim cover for encapsulating the heads of the screws, and which is securable with respect to the rim of the canopy. The rim cover has opposed fingers each having a lower end affixed to the rim cover and an opposing upper end, a notch between the opposed upper and lower ends, and opposed front and rear faces.

There is a gap between the rear face of each of the fingers and the rim cover. The fingers are flexurally resilient to concurrently admit the sides of the heads of the respective screws into the notches of the respective fingers to embrace and secure the heads of the screws. In one embodiment, the notches are directed away from each other and the sides of the screws are outer sides of the screws. In another embodiment, the notches are directed toward each other and the sides of the screws are inner sides of the screws. The fingers are also flexurally resilient in reciprocal directions relative to the rim cover. The rim cover includes an upper edge receivable in juxtaposition with the ceiling. The rim cover also includes an in turned lower edge receivable in juxtaposition with the canopy.

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, mounting screws each extending through the rim of the canopy and engaged to the hanger bracket and having a head residing external of the rim of the canopy, and a rim cover for encapsulating the heads of the screws and securable with respect to the rim of the canopy. A finger has a lower end affixed to the rim cover and an opposing upper end, a front face and an opposing rear face. There is a gap between the rear face of the finger and the rim cover. The finger is flexurally resilient in reciprocal directions relative to the rim cover. An indentation is formed in the front face of the finger. The indentation is bound on either side by opposed, substantially parallel sidewalls formed in the finger, and is bound on either end by opposed, substantially parallel top and bottom walls formed in the finger extending between the opposed sidewalls. A protrusion is carried by the rim, and is matingly receivable with the indentation to detachably engage the protrusion with respect to the indentation. The opposed sidewalls and the opposed top and bottom walls formed in the finger are to interact with the protrusion to constrain the rim cover from horizontal and vertical displacement with respect to the canopy. A beveled surface is formed in the upper end of the finger to initially receive the protrusion to deflect the finger relative to the rim cover in preparation for presentation of the protrusion relative to the indentation. The rim cover includes an upper edge receivable in juxtaposition with the ceiling, and an in turned lower edge receivable in juxtaposition with the canopy. There are spacers formed between the canopy and the rim cover to interact between the canopy and the rim cover to set the rim cover at a substantially fixed circumferential spacing relative to the canopy. The spacers are preferably formed in the rim cover. In the present embodiment, the indentation is carried by the finger and the corresponding protrusion is carried by the rim, and this arrangement can be reversed in an alternate embodiment.

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, a continuous groove formed in the upper rim of the canopy, mounting screws each extending through the rim of the canopy and engaged to the hanger bracket and having a head residing external of the rim of the canopy in the continuous groove, and a rim cover for encapsulating the heads of the screws in the continuous groove and securable with respect to the rim of the canopy. A finger has a lower end affixed to the rim cover and an opposing upper end, a front face and an opposing rear face. There is a gap between the rear face of the finger and the rim cover. The finger is flexurally resilient in reciprocal directions relative to the rim cover. A protrusion is carried by the front face of the finger, which is matingly receivable with the continuous groove to detachably engage the rim cover to the canopy. A beveled surface is formed in the upper end of the finger to initially receive an abutment formed in the canopy to deflect the finger relative to the rim cover in preparation for presentation of the protrusion relative to the continuous groove. The rim cover includes an upper edge receivable in juxtaposition with the ceiling, and an in turned lower edge receivable in juxtaposition with the canopy. Spacers are formed between the canopy and the rim cover to interact between the canopy and the rim cover to set the rim cover at a substantially fixed circumferential spacing relative to the canopy. The spacers are preferably formed in the rim cover.

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, mounting screws each extending through the rim of the canopy and engaged to the hanger bracket and having a head residing external of the rim of the canopy, a circumferentially elongate slot formed through the rim of the canopy, and a rim cover for encapsulating the heads of the screws in the continuous groove and securable with respect to the rim of the canopy. A finger has a lower end affixed to the rim cover and an opposing upper end, a front face and an opposing rear face. There is a gap between the rear face of the finger and the rim cover, and the finger is flexurally resilient in reciprocal directions relative to the rim cover. A protrusion is carried by the front face of the finger, which is matingly receivable in the circumferentially elongate slot formed through the rim of the canopy to detachably engage the rim cover to the canopy. A beveled surface is formed in the upper end of the finger to initially an abutment formed in the canopy to deflect the finger relative to the rim cover in preparation for presentation of the protrusion relative to the slot. The rim cover includes an upper edge receivable in juxtaposition with the ceiling, and an in turned lower edge receivable in juxtaposition with the canopy. Spacers are formed between the canopy and the rim cover to interact between the canopy and the rim cover to set the rim cover at a substantially fixed circumferential spacing relative to the canopy. The spacers are preferably formed in the rim cover. In the present embodiment, the slot is carried by the rim of the canopy and the corresponding protrusion is carried by the finger, and this arrangement can be reversed in an alternate embodiment.

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and including an upper rim terminating with an upper marginal edge receivable in juxtaposition with the ceiling, and mounting screws each extending through the rim of the canopy and engaged to the hanger bracket and having a head residing external of the rim of the canopy. A circumferentially elongate notch is formed in the upper rim of the canopy. The notch extends downwardly into the upper rim of the canopy from the upper marginal edge terminating with a lower edge extending between opposed side edges formed in the canopy. The hanger assembly further includes a rim cover for encapsulating the heads of the screws in the continuous groove and securable with respect to the rim of the canopy. A finger has a lower end affixed to the rim cover and an opposing upper end, a front face and an opposing rear face. There is a gap between the rear face of the finger and the rim cover. The finger is flexurally resilient in reciprocal directions relative to the rim cover. A protrusion is carried by the front face of the finger, which is matingly receivable in the notch formed in the canopy and which is detachably receivable against the lower edge of the notch between the opposed side edges to suspend the rim cover from the canopy. A beveled surface is formed in the upper end of the finger to initially receive an abutment formed in the canopy to deflect the finger relative to the rim cover in preparation for presentation of the protrusion relative to the notch. The rim cover includes an upper edge receivable in juxtaposition with the ceiling, and an in turned lower edge receivable in juxtaposition with the canopy. Spacers are formed between the canopy and the rim cover to interact between the canopy and the rim cover to set the rim cover at a substantially fixed circumferential spacing relative to the canopy. The spacers are preferably formed in the rim cover.

### BRIEF DESCRIPTION OF THE DRAWINGS

Referring to the drawings:

FIG. 1 is a partially exploded perspective view of a ceiling fan hanger assembly constructed in accordance with the principles of the instant invention;

FIG. 2 is a side elevation view of the hanger assembly of FIG. 1 as it would appear fully assembled;

FIG. 3 is a top plan view of the fully assembled hanger assembly of FIG. 2;

FIG. 4 is a top plan view of a rim cover of the ceiling fan hanger assembly of FIG. 1;

FIG. 5 is an enlarged vertical sectional view showing an embodiment of an engagement assembly for engaging a rim cover to a canopy of the ceiling fan hanger assembly of FIG. 1;

FIG. 6 is an enlarged sectional view taken along line 6-6 of FIG. 5;

FIG. 7 is a sectional view taken along line 7-7 of FIG. 6;

FIG. 8 is a partially exploded perspective view of an alternate embodiment of a ceiling fan hanger assembly constructed in accordance with the principles of the instant invention;

FIG. 9 is a top plan view of the fully assembled hanger assembly of FIG. 8;

FIG. 10 is a top plan view of a rim cover of the ceiling fan hanger assembly of FIG. 8;

FIG. 11 is an enlarged vertical sectional view showing an embodiment of an engagement assembly for engaging a rim cover to a canopy of the ceiling fan hanger assembly of FIG. 8;

FIG. 12 is an enlarged sectional view taken along line 12-12 of FIG. 11;

FIG. 13 is a fragmented side elevation view illustrating a rim cover clamped to a canopy of the ceiling fan hanger assembly of FIG. 8;

FIG. 14 is a partially exploded perspective view of yet another alternate embodiment of a ceiling fan hanger assembly constructed in accordance with the principles of the instant invention;

FIG. 15 is a top plan view of the fully assembled hanger assembly of FIG. 14;

FIG. 16 is a top plan view of a rim cover of the ceiling fan hanger assembly of FIG. 14;

FIG. 17 is an enlarged vertical sectional view showing an embodiment of an engagement assembly for engaging a rim cover to a canopy of the ceiling fan hanger assembly of FIG. 14;

FIG. 18 is an enlarged sectional view taken along line 18-18 of FIG. 17;

FIG. 19 is a fragmented side elevation view illustrating a rim cover clamped to a canopy of the ceiling fan hanger assembly of FIG. 8;

FIG. 20 is a partially exploded perspective view of still another alternate embodiment of a ceiling fan hanger assembly constructed in accordance with the principles of the instant invention;

FIG. 21 is a perspective view of the hanger assembly of FIG. 20 as it would appear when fully assembled;

FIG. 22 is a top plan view of the assembly illustrated in FIG. 21;

FIG. 23 is a side elevation view of the assembly illustrated in FIG. 21;

FIG. 24 is an enlarged vertical section view showing an embodiment of an engagement assembly for engaging a rim cover to a canopy of the ceiling fan hanger assembly of FIG. 20;

FIG. 25 is an enlarged perspective view showing an element of the engagement assembly of FIG. 24 carried by the rim cover;

FIG. 26 is a section view taken along line 26-26 of FIG. 25;

FIG. 27 is a section view taken along line 27-27 of FIG. 25;

FIG. 28 is a partially exploded perspective view of yet still another alternate embodiment of a ceiling fan hanger assembly constructed in accordance with the principles of the instant invention;

FIG. 29 is a perspective view of the hanger assembly of FIG. 28 as it would appear when fully assembled;

FIG. 30 is a top plan view of the assembly illustrated in FIG. 29;

FIG. 31 is a side elevation view of the assembly illustrated in FIG. 29;

FIG. 32 is a side elevation view of a canopy of the hanger assembly of FIG. 28;

FIG. 33 is an enlarged vertical section view showing an embodiment of an engagement assembly for engaging a rim cover to a canopy of the ceiling fan hanger assembly of FIG. 28;

FIG. 34 is an enlarged perspective view showing an element of the engagement assembly of FIG. 33 carried by the rim cover;

FIG. 35 is a partially exploded perspective view of still another alternate embodiment of a ceiling fan hanger assembly constructed in accordance with the principles of the instant invention;

FIG. 36 is a perspective view of the hanger assembly of FIG. 35 as it would appear when fully assembled;

FIG. 37 is a top plan view of the assembly illustrated in FIG. 36;

FIG. 38 is a side elevation view of the assembly illustrated in FIG. 36;

FIG. 39 is a side elevation view of a canopy of the hanger assembly of FIG. 35;

FIG. 40 is an enlarged vertical section view showing an embodiment of an engagement assembly for engaging a rim cover to a canopy of the ceiling fan hanger assembly of FIG. 35;

FIG. 41 is an enlarged perspective view showing an element of the engagement assembly of FIG. 40 carried by the rim cover;

FIG. 42 is a partially exploded perspective view of yet another alternate embodiment of a ceiling fan hanger assembly constructed in accordance with the principles of the instant invention;

FIG. 43 is a perspective view of the hanger assembly of FIG. 42 as it would appear when fully assembled;

FIG. 44 is a top plan view of the assembly illustrated in FIG. 43;

FIG. 45 is a side elevation view of the assembly illustrated in FIG. 43;

FIG. 46 is a side elevation view of a canopy of the hanger assembly of FIG. 42;

FIG. 47 is an enlarged vertical section view showing an embodiment of an engagement assembly for engaging a rim cover to a canopy of the ceiling fan hanger assembly of FIG. 42; and

FIG. 48 is an enlarged perspective view showing an element of the engagement assembly of FIG. 47 carried by the rim cover.

### DETAILED DESCRIPTION

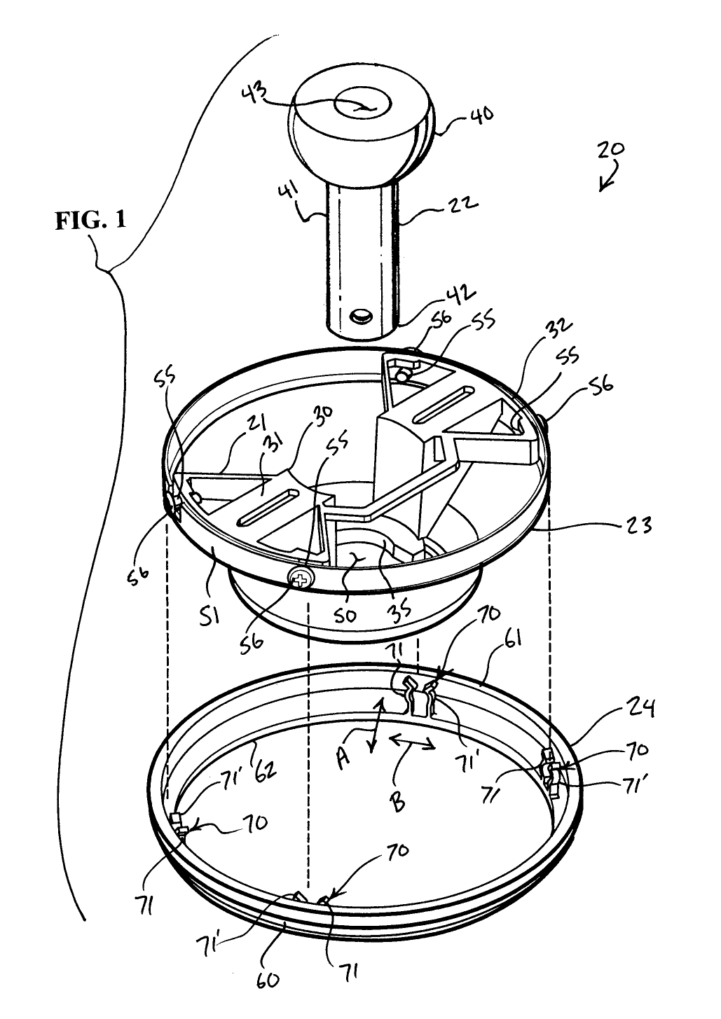

Turning now to the drawings, in which like reference characters indicate corresponding elements throughout the several views, attention is first directed to FIG. 1 in which is seen a ceiling fan hanger assembly, incorporating the teachings of the instant invention and generally designated by reference character 20. Hanger assembly 20 includes hanger bracket 21, down rod 22, canopy 23, and rim cover 24.

Hanger bracket 21 includes base 30, upper surface 31 and peripheral sidewall 32. Spherical ball socket 35 is formed into bracket 21 at a generally central location. Slots 36 extending through base 30 accommodate mounting screws which pass through slots 36 and threadedly engage an overhead support member. Although the overhead support member is not specifically illustrated, those skilled in the art will readily appreciate that conventional overhead support members include electrical junction boxes, especially devised struts and beams, all of which are considered to be integral with a ceiling. Further, when hanger bracket 21 is secured to the overhead support member, upper surface 31 abuts the ceiling.

Down rod 22 includes ball 40 which is to be matingly received within socket 35 in a conventional manner. Shaft 41, having lower end 42, depends from ball 40. It will be readily understood by those skilled in the art that the lower terminal portion of shaft 41 adjacent lower end 42 can be threaded or otherwise configured for securement to a conventional ceiling fan. Bore 43 extending longitudinally through ball 40 and shaft 41 accommodate the electrical wires which extend from a junction box to the fan.

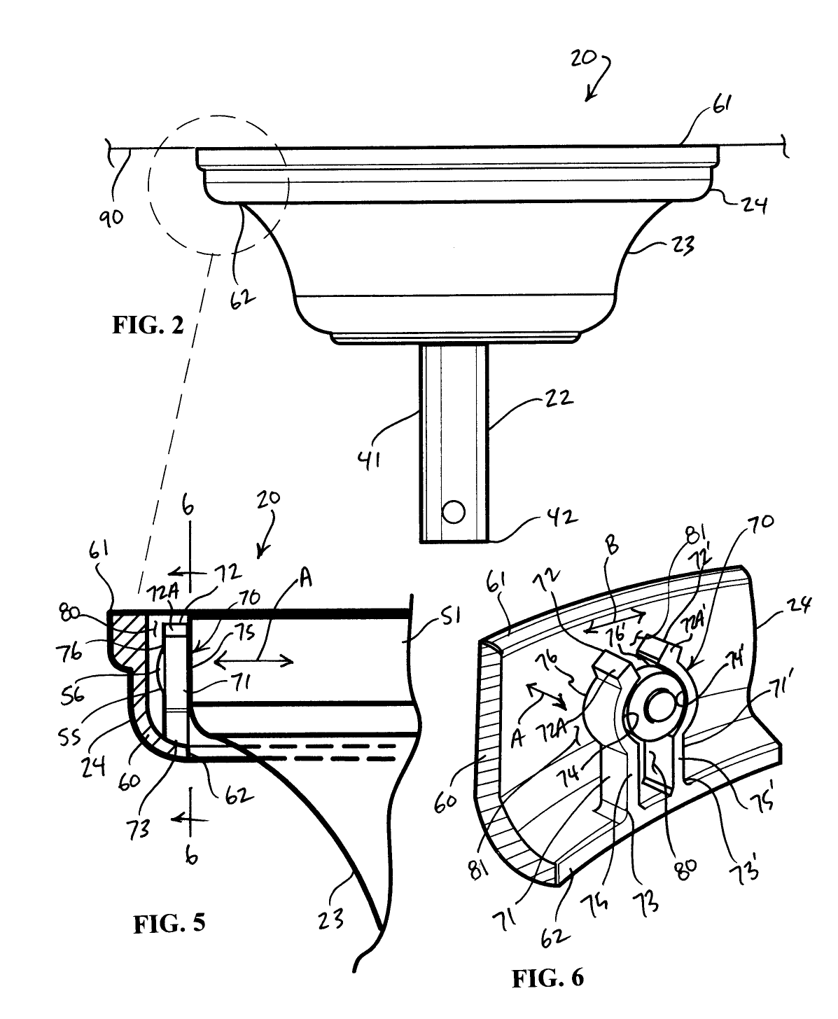

Canopy 23 is generally in the shape of an inverted dome as illustrated in FIG. 1 and FIG. 2. Referencing FIG. 1, canopy 23 includes a generally central opening 50 for receiving shaft 41 there through. Canopy 23 also includes an upper rim 51 sized and shaped to receive peripheral sidewall 32 of hanger bracket 21 therein.

A plurality of openings extend through upper rim 51 of canopy 23, which are spaced to align with threaded bores in hanger bracket 21. A screw 55 extends through each of the openings through upper rim 51 and threadedly engaged with a respective threaded bore in peripheral sidewall 32 of hanger bracket 21. As illustrated in FIG. 1 and FIG. 3, a head 56 of each respective screw 55 resides externally of upper rim 51 of canopy 23.

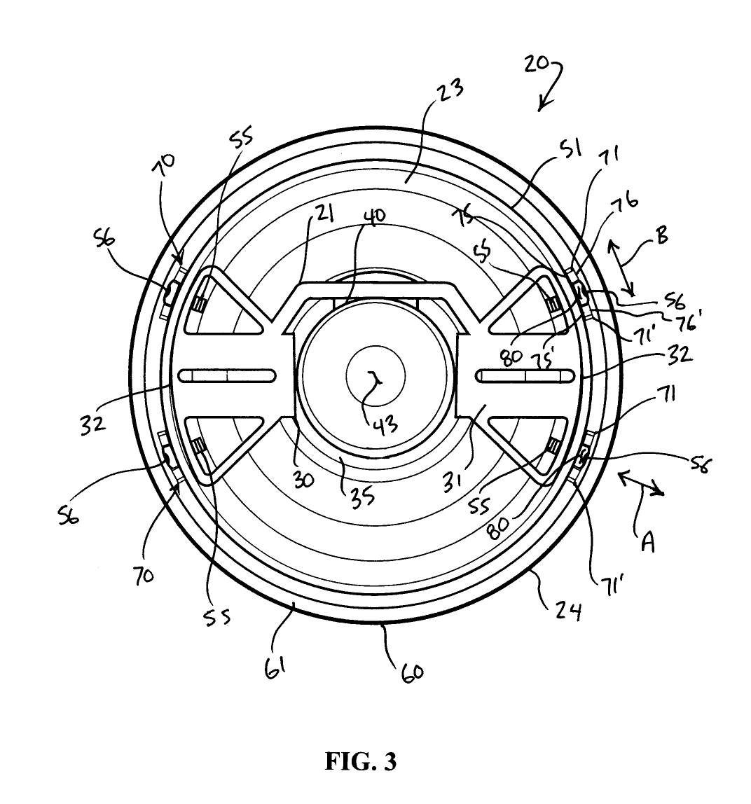

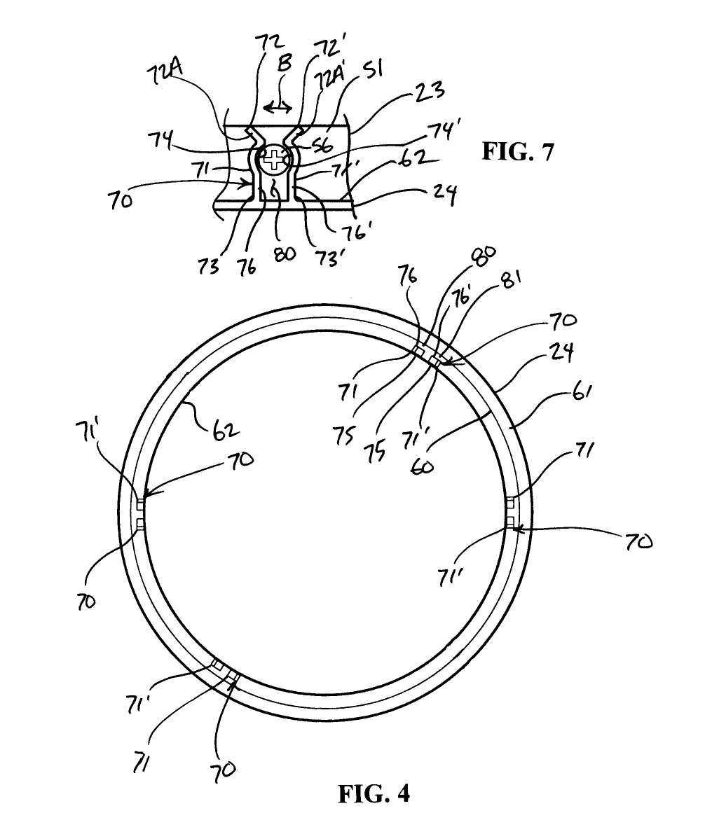

Rim cover 24, illustrated in further detail in FIG. 2, FIG. 3, and FIG. 4, includes sidewall 60 having upper edge 61 and lower edge 62 (lower edge 62 not illustrated in FIG. 3). Rim cover 34 is sized to extend about and encapsulate heads 56 of screws 55. A plurality of clamps 70 are formed inwardly with respect to sidewall 60.

Clamps 70 are fabricated of a resilient material. Clamps 70 are identical to each other and each include, as shown in FIG. 6 and FIG. 7, opposed and confronting upstanding fingers 71 and 71′ integrally formed with sidewall 60. Fingers 71 and 71′ are the minor image of one another and are substantially coextensive. Fingers 71 have upper ends 72 and 72′ and opposed lower ends 73 and 73′, respectively, affixed to sidewall 60 of rim cover 24 just inboard of lower edge 62. Fingers 71 and 71′ project upwardly from lower edge 62 and terminate with upper ends 72 and 72′, respectively, which upper ends 72 and 72′ are directed toward upper edge 61.

Fingers 71 and 71′ are spaced apart from each other, in which there is a gap 80 therebetween extending from and between upper ends 72 and 72′ of fingers 71 and 71′ to lower ends 73 and 73′ of fingers 71 and 71′. Notches 74 and 74′ are formed in fingers 71 and 71′, respectively. Notch 74 is formed between upper and lower ends 72 and 73 of finger 71, and notch 74′ is formed between upper and lower ends 72′ and 73′ of finger 71′. Notches 74 and 74′ oppose and face inwardly toward one other and are substantially equal in size. Finger 71 has opposed front and rear faces 75 and 76, and finger 71′ has opposed front and rear faces 75′ and 76′. Rear faces 76 and 76′ face sidewall 60, in which there is a gap 81 therebetween rear face 76 and sidewall 60 and a gap 81′ therebetween rear face 76′ and sidewall 60.

Upper ends 72 and 72′ of fingers 71 and 71′ are formed with out turned portions 72A and 72A′, and are directed inwardly with respect to each other or are otherwise in turned with respect to each other, in which the width of gap 80 between upper ends 72 and 72′ of fingers 71 and 71′ is narrowed with respect to the width of gap 80 between notches 74 and 74′. Out turned portions 72A and 72A′ are out turned with respect to notches 74 and 74′, respectively. Fingers 71 and 71′ are flexurally resilient in reciprocal directions relative to sidewall 60 of rim cover 24 as indicated by the double arrowed line A in FIG. 1, FIG. 3, FIG. 4, FIG. 5, and FIG. 6, and are flexurally resilient in reciprocal directions relative to each other as indicated by the double arrowed line B in FIG. 1, FIG. 3, FIG. 4, FIG. 6, and FIG. 7.

Referencing FIG. 3, heads 56 of screws 55 reside within the gaps 80 between fingers 71 and 71′ of the respective clamps 70, and reside within and are held within the notches 74 and 74′ in fingers 71 and 71′ of the respective clamps 70 when hanger assembly 20 is assembled and secured to an overhead support member. Accordingly, rim cover 24 is received is clamp engagement with heads 56 of screws 55 to secure rim cover 24 with respect to canopy 23. Clamps 70 are spaced apart with respect to each other, and are positioned to correspond to the positioning of the heads 56 of the respective screws 55 securing canopy 23 to hanger bracket 21, and are aligned with the heads 56 of the respective screws 55 when fitting rim cover 24 about the upper rim 51 of canopy 23. The integral formation of sidewall 60 with lower ends 73 and 73′ of fingers 71 and 71′ supporting notches 74 and 74′ is preferred, but it will be understood that lower ends 73 and 73′ of fingers 71 and 71′ can be welded to sidewall 60, adhesively affixed to sidewall 60, or rigidly affixed to sidewall 60 in other ways.

FIG. 5 and FIG. 7 illustrate head 56 of screw 55 as it would appear positioned in gap 80 between fingers 71 and 71′, positioned in notches 74 and 74′, and notches 74 and 74′ of fingers 71 and 71′ engaging and embracing head 56. The flexural nature of fingers 71 and 71′ is thus provided in such a way that fingers 71 and 71′ bias toward head 56 biasing notches 74 and 74′ toward and against head 56 of screw 55 when installed therewith for providing a clamping engagement or embracement of head 56 by and between fingers 71 and 71′, according to the principle of the invention. When rim cover 24 is clamp engaged with respect to upper rim 51 of canopy 23 such that clamps 70 are clamp engaged to the heads 56 of the respective screws 55, fingers 71 and 71′ of the respective clamps 70 are received in juxtaposition with respect to upper rim 51 of canopy 23 as shown in FIG. 3. This aspect is also illustrated in FIG. 5, which shows clamp 100 clamp engaged to head 56 of screw 55, and finger 71 of clamp 70 received in juxtaposition with respect to upper rim 51 of canopy 23.

Fingers 71 and 71′ of each clamp 70 are flexurally resilient in reciprocal directions relative to each other to admit head 56 of screw 55 into gap 80 and into notches 74 and 74′ formed in fingers 71 and 71′ to embrace and secure head 56 of screw 55. The flexural character of fingers 71 and 71′ allow them to flex outwardly and away from each other as needed for installing rim cover 24 to canopy 23 and removing rim cover 24 from canopy 24. Rim cover 24 is brought upwardly toward upper rim 51 of canopy 23 and is maneuvered to register clamps 70 with the respective heads 56 of screws 55. With respect to each clamp 70, head 56 of screw 55 is initially received against out turned portions 72A and 72A′ of fingers 71 and 71′. Through the application of an upward force, head 56 acts on out turned portions 72A and 72A′ of fingers 71 and 71′ spreading fingers 71 apart widening gap 80 between upper ends 72 and 72′ permitting head 56 to pass into gap 80 the notches 74 and 74′, in which fingers 71 and 71′ then flex inwardly with respect to each other toward the head 56 engaging notches 74 and 74′ of fingers 71 against head 56 clamping and embracing head 56 thereby clamping and securing head 56 and clamp securing rim cover 24 with respect to upper rim 51 of canopy 23.

As further seen in FIG. 2, when hanger assembly 20 is assembled and installed, upper edge 61 of rim cover 24 resides in juxtaposition with ceiling 90. Lower edge 62 of rim cover 24 is in turned to reside in juxtaposition with canopy 24 as illustrated in FIG. 2 and FIG. 5.

Hanger assembly 20 includes four screws 55 and four corresponding clamps 70 in the present embodiment. Those of ordinary skill will readily appreciate that hanger assembly 20 may incorporate any number of screws 55 to secure canopy 23 to hanger bracket 21, and that rim cover 24 may be constructed with the appropriate number of clamps 70 to correspond with whatever number of screws 55 hanger assembly 20 utilizes.

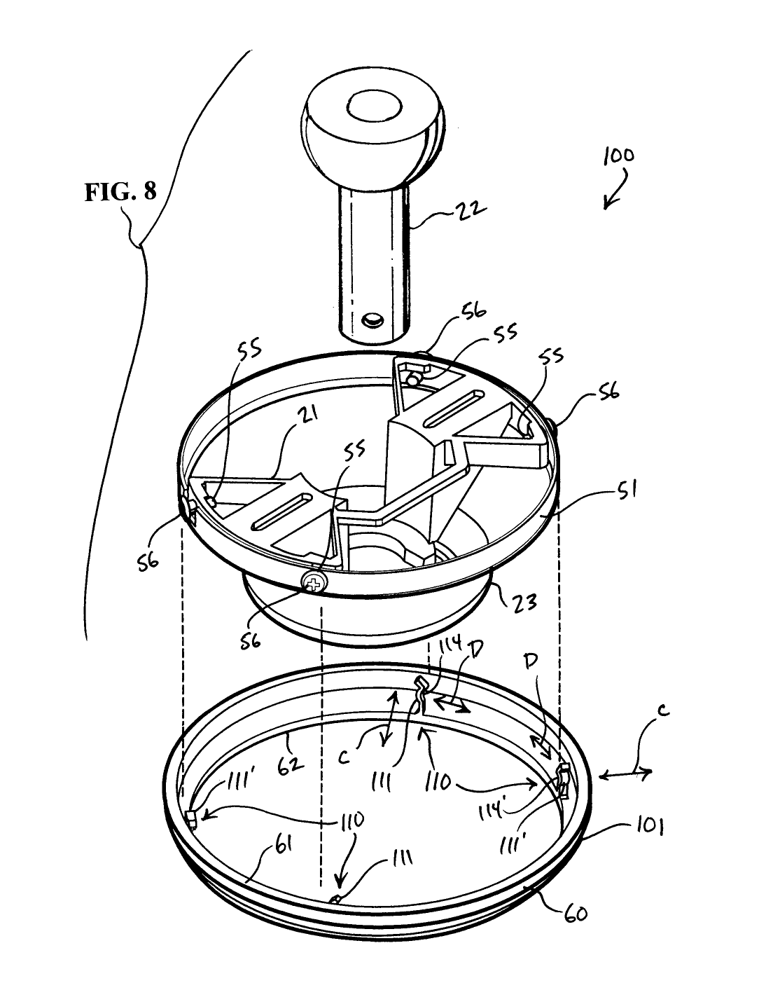

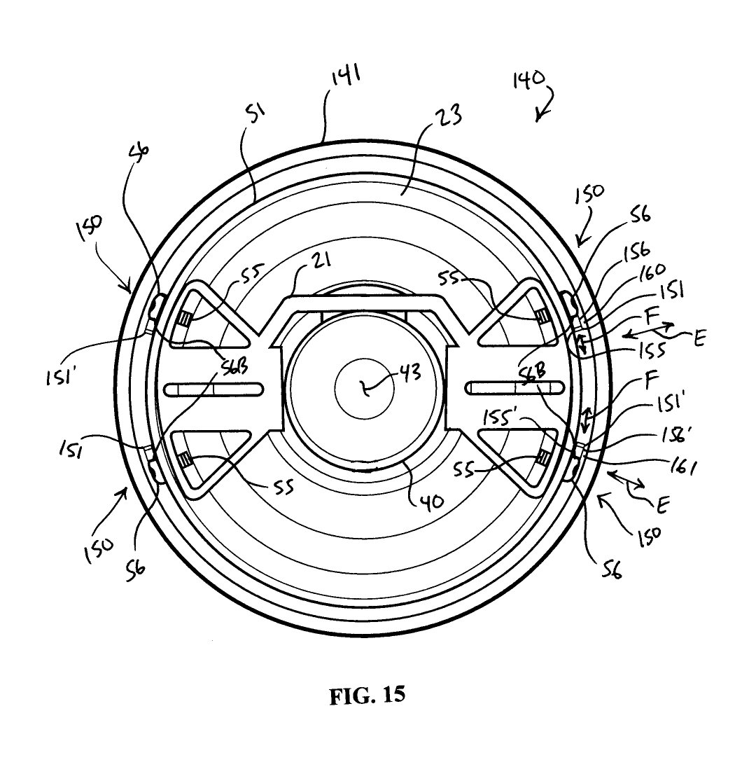

In hanger assembly 20, clamps 70 formed in rim cover 24 each relate to the head 56 of one of the respective screws 56 securing canopy 23 to hanger bracket 21. In the ensuing two alternate embodiments, the first of which is presented in FIGS. 8-13 and the second of which is presented in FIGS. 14-19, the clamps formed in the rim covers each relate to two screw heads.

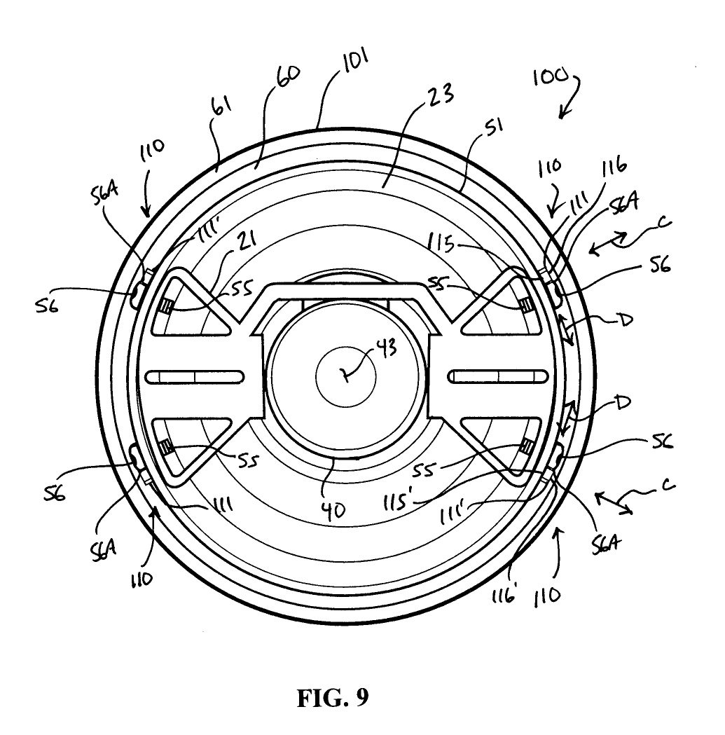

Reference is now made to FIGS. 8 and 9, in which is seen an alternate embodiment of a ceiling fan hanger assembly, incorporating the teachings of the instant invention and generally designated by reference character 100. In common with hanger assembly 20, hanger assembly 100 shares hanger bracket 21, down rod 22, canopy 23, and screws 55 formed with heads 56, and also includes an alternate embodiment of a rim cover denoted at 101. The details with respect to bracket 21, down rod 22, and canopy 23 and the assembly thereof are as in the embodiment of hanger assembly designated 20, the details of which apply equally with respect to hanger assembly 100 and will not again be discussed.

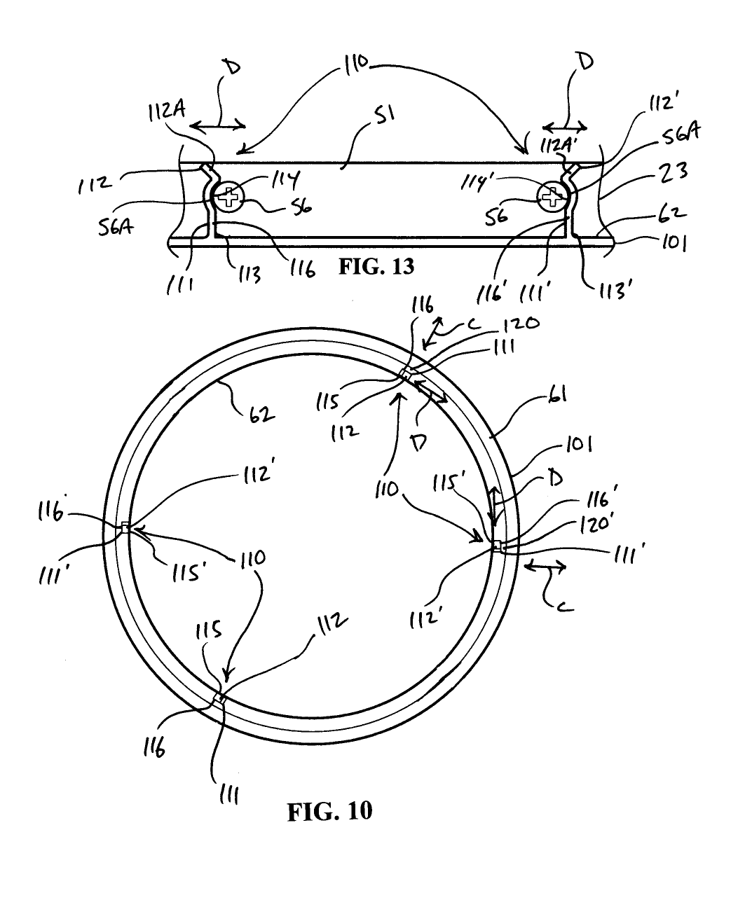

Rim cover 101, illustrated in detail in FIG. 8, FIG. 9, and FIG. 10, is common to rim cover 24 in that rim cover 100 shares upper edge 61 and lower edge 62 (lower edge 62 not illustrated in FIG. 9) and which is sized to extend about and encapsulate heads 56 of screws 55 as in hanger assembly 20. A plurality of clamps, denoted generally at 110, are formed inwardly with respect to sidewall 60 that, unlike clamps 70 in hanger bracket 20, are each configured to clamp the heads 56 of two screws 55.

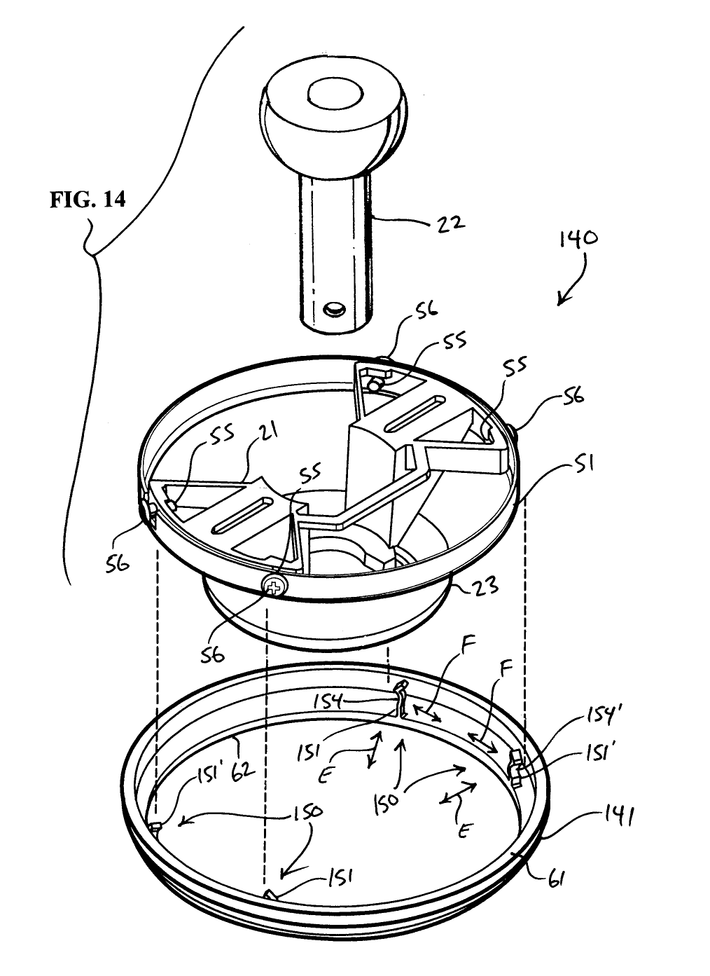

Clamps 110 are fabricated of a resilient material and are identical to each other. Referencing FIG. 13, clamps 110 each include opposed and confronting upstanding fingers 111 and 111′ integrally formed with sidewall 60. Fingers 111 and 111′ are the minor image of one another and are substantially coextensive. Fingers 101 have upper ends 112 and 112′ and opposed lower ends 113 and 113′, respectively, affixed to sidewall 60 of rim cover 101 just inboard of lower edge 62. Fingers 111 and 111′ project upwardly from lower edge 62 and terminate with upper ends 112 and 112′, respectively, which upper ends 112 and 112′ are directed toward upper edge 61.

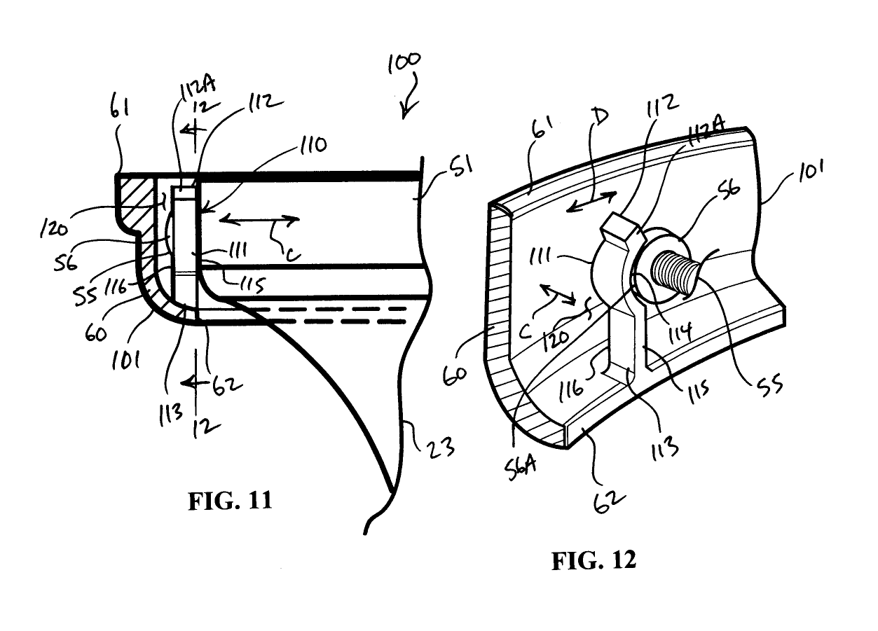

Rim cover 100 is generally circular in shape, and fingers 111 and 111′ are circumferentially spaced apart from each other and are further positioned to relate to the heads 56 of a pair of respective screws 55 securing canopy 23 to hanger bracket 21. Notches 114 and 114′ are formed in fingers 111 and 111′, respectively. Notch 114 is formed between upper and lower ends 112 and 113 of finger 111, and notch 114′ is formed between upper and lower ends 112′ and 113′ of finger 111′. Notches 114 and 114′ oppose and substantially face inwardly toward one another and are substantially equal in size. Finger 111 has opposed front and rear faces 115 and 116 denoted in FIG. 9, FIG. 11, and FIG. 12, and finger 111′ has opposed front and rear faces 115′ and 116′ denoted in FIG. 9. Rear faces 116 and 116′ face sidewall 60, in which there is a gap 120 therebetween rear face 116 and sidewall 60 illustrated in FIG. 9, FIG. 10, FIG. 11, and FIG. 12, and a gap 120′ therebetween rear face 116′ and sidewall 60 illustrated in FIG. 9 and FIG. 10.

Upper ends 112 and 112′ of fingers 111 and 111′ are formed with out turned portions 112A and 112A′. Out turned portions 112A and 112A′ are out turned with respect to notches 114 and 114′, respectively. Fingers 111 and 111′ are flexurally resilient in reciprocal directions relative to sidewall 60 of rim cover 101, each as indicated by a double arrowed line C in FIG. 8, FIG. 9, FIG. 10, FIG. 11, and FIG. 12, and are flexurally resilient in reciprocal directions substantially relative to each other, each as indicated by a double arrowed line D in FIG. 8, FIG. 9, FIG. 10, FIG. 12, and FIG. 13.

Referencing FIG. 13, heads 56 of screws 55 reside between fingers 111 and 111′ of clamp 110, and reside within and are held within the notches 114 and 114′ in fingers 111 and 111′ of clamp 110 when hanger assembly 20 is assembled and secured to an overhead support member, in which notches 114 and 114′ are applied against outer sides 56A of the heads 56 of the respective screws 55. Accordingly, rim cover 101 is received is clamp engagement with heads 56 of screws 55 to secure rim cover 101 with respect to canopy 23. Fingers 111 and 111′ are spaced apart with respect to each other, and are positioned to correspond to the positioning of the heads 56 of the respective two screws 55 securing canopy 23 to hanger bracket 21, and are aligned with the heads 56 of the respective two screws 55 when fitting rim cover 101 about the upper rim 51 of canopy 23. The integral formation of sidewall 60 with lower ends 113 and 113′ of fingers 111 and 111′ supporting notches 114 and 114′ is preferred, but it will be understood that lower ends 113 and 113′ of fingers 111 and 111′ can be welded to sidewall 60, adhesively affixed to sidewall 60, or rigidly affixed to sidewall 60 in other ways.

FIG. 13 illustrate the heads 56 of the two screws 55 positioned between fingers 111 and 111′, and the outer sides 56A of the heads 56 of the respective two screws positioned in or otherwise received by notches 114 and 114′ formed in the respective fingers 111 and 111′ engaging and embracing heads 56. FIG. 12 is an enlarged view illustrating head 56 of screw 55 located in notch 114 formed in finger 111. The flexural nature of fingers 111 and 111′ is thus provided in such a way that fingers 111 and 111′ bias toward the outer sides 56A of the respective heads 56 biasing notches 114 and 114′ toward and against the outer sides 56A of the respective heads 56 when installed therewith for providing a clamping engagement or embracement of heads 56 by and between fingers 111 and 111′, according to the principle of the invention. When rim cover 24 is clamp engaged with respect to upper rim 51 of canopy 23 such that clamps 110 are clamp engaged to the heads 56 of two screws 55, fingers 111 and 111′ of the clamp 110 are received in juxtaposition with respect to upper rim 51 of canopy 23 as illustrated in FIG. 9. This aspect is also illustrated in FIG. 5, which shows finger 111 of clamp 110 clamp engaged to head 56 of screw 55, and finger 111 of clamp 110 received in juxtaposition with respect to upper rim 51 of canopy 23.

Fingers 111 and 111′ of each clamp 110 are flexurally resilient in reciprocal directions to concurrently admit heads 56 of screws 55 between fingers 111 and 111′ and into notches 114 and 114′ formed in fingers 111 and 111′, respectively, to embrace and secure heads 56 of screws 55. The flexural character of fingers 111 and 111′ allow them to flex outwardly and away from each other as needed for installing rim cover 101 to canopy 23 and removing rim cover 101 from canopy 101. Rim cover 101 is brought upwardly toward upper rim 51 of canopy 23 and is maneuvered to register fingers 111 and 111′ with the respective heads 56 of screws 55. The heads 56 of the respective screws 55 are initially received against out turned portions 112A and 112A′ of the respective fingers 111 and 111′. Through the application of an upward force, heads 56 of the respective screws 55 act on out turned portions 112A and 112A′ of fingers 111 and 111′, respectively, spreading fingers 111 and 111′ apart from each other permitting the heads 56 of the respective screws 55 to pass between fingers 111 and 111′ to notches 114 and 114′, in which fingers 111 and 111′ then flex inwardly with respect to each other toward the outer sides 56A of the heads 56 of the respective screws 55 engaging notches 114 and 114′ of fingers 101 against the outer sides 56A of the heads 56 of the respective screws 55 clamping and embracing heads 56 between fingers 111 and 111′ thereby clamping and securing heads 56 and clamp securing rim cover 101 with respect to upper rim 51 of canopy 23.

Like hanger assembly 20 illustrated in FIG. 2, when hanger assembly 100 is assembled and installed, upper edge 61 of rim cover 101 resides in juxtaposition with the ceiling. Further, lower edge 62 of rim cover 101 is in turned to reside in juxtaposition with canopy 101 as illustrated in FIG. 11.

Those of ordinary skill will readily appreciate that hanger assembly 100 may incorporate any number of screws 55 to secure canopy 23 to hanger bracket 21, and that rim cover 101 may be constructed with the appropriate number of clamps 110 to correspond the number of screws 55 hanger assembly 100 utilizes, with the understanding that each clamp 110 relates to two heads of two screws.

Reference is now made to FIGS. 14 and 15, in which is seen yet another alternate embodiment of a ceiling fan hanger assembly, incorporating the teachings of the instant invention and generally designated by reference character 140. In common with hanger assembly 20, hanger assembly 140 shares hanger bracket 21, down rod 22, canopy 23, and screws 55 formed with heads 56, and also includes an alternate embodiment of a rim cover denoted at 141. The details with respect to bracket 21, down rod 22, and canopy 23 and the assembly thereof are as in the embodiment of hanger assembly designated 20, the details of which apply equally with respect to hanger assembly 140 and will not again be discussed.

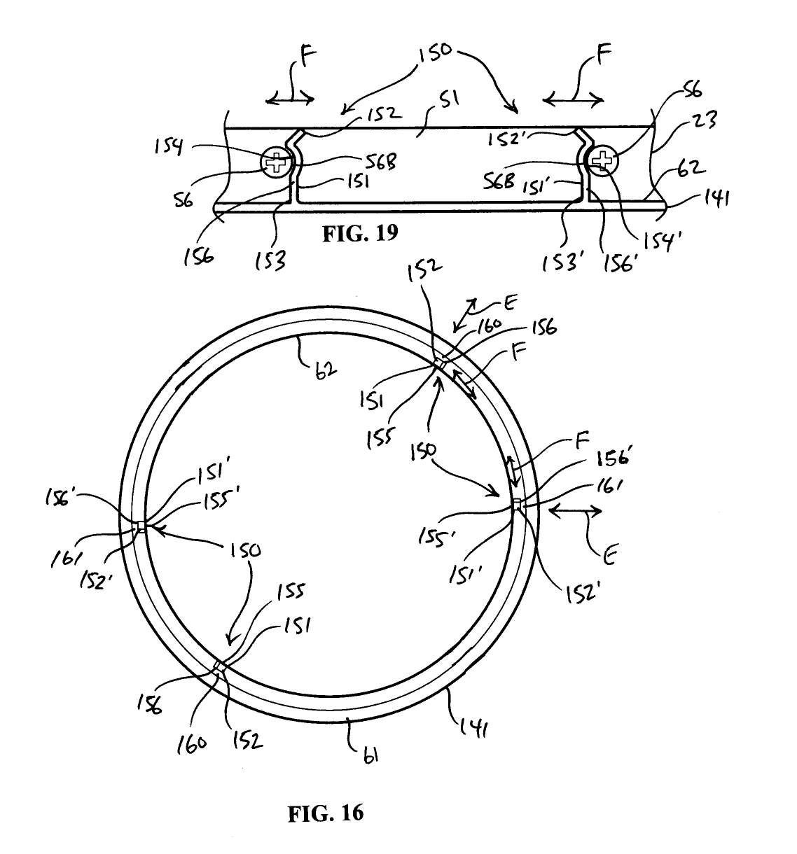

Rim cover 141, illustrated in detail in FIG. 14, FIG. 15, and FIG. 16, is common to rim cover 24 in that rim cover 140 shares upper edge 61 and lower edge 62 (lower edge 62 not illustrated in FIG. 15) and which is sized to extend about and encapsulate heads 56 of screws 55 as in hanger assembly 20. A plurality of clamps, denoted generally at 150, are formed inwardly with respect to sidewall 60 that, unlike clamps 70 in hanger bracket 20, are each configured to clamp the heads 56 of two screws 55.

Clamps 150 are fabricated of a resilient material and are identical to each other. Referencing FIG. 19, clamps 150 each include opposed and confronting upstanding fingers 151 and 151′ integrally formed with sidewall 60. Fingers 151 and 151′ are the minor image of one another and are substantially coextensive. Fingers 141 have upper ends 152 and 152′ and opposed lower ends 153 and 153′, respectively, affixed to sidewall 60 of rim cover 141 just inboard of lower edge 62. Fingers 151 and 151′ project upwardly from lower edge 62 and terminate with upper ends 152 and 152′, respectively, which upper ends 152 and 152′ are directed toward upper edge 61.

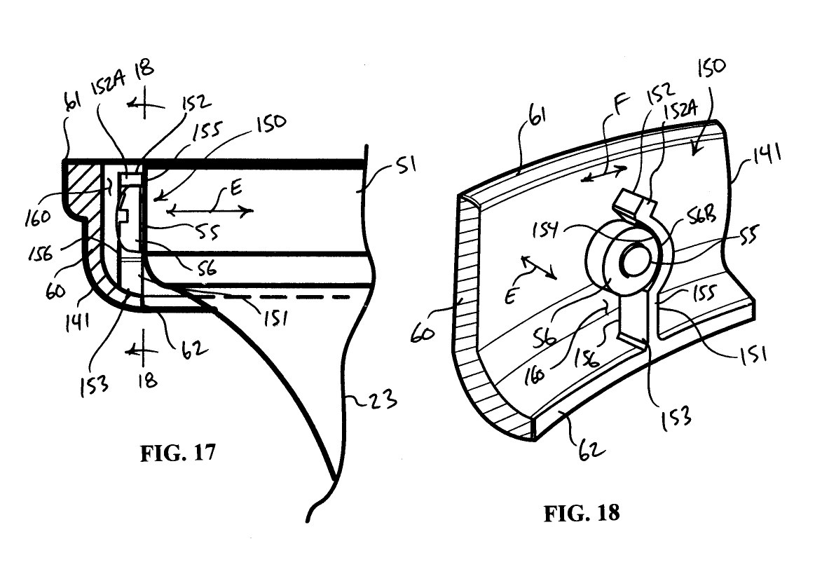

Rim cover 140 is generally circular in shape, and fingers 151 and 151′ are circumferentially spaced apart from each other and are further positioned to relate to the heads 56 of a pair of respective screws 55 securing canopy 23 to hanger bracket 21. Notches 154 and 154′ are formed in fingers 151 and 151′, respectively. Notch 154 is formed between upper and lower ends 152 and 153 of finger 151, and notch 154′ is formed between upper and lower ends 152′ and 153′ of finger 151′. Notches 154 and 154′ oppose and substantially face outwardly away from one another and are substantially equal in size. Finger 151 has opposed front and rear faces 155 and 156 denoted in FIG. 15, FIG. 17, and FIG. 18, and finger 151′ has opposed front and rear faces 155′ and 156′ denoted in FIG. 15. Rear faces 156 and 156′ face sidewall 60, in which there is a gap 160 therebetween rear face 156 and sidewall 60 illustrated in FIGS. 15 and 16, and a gap 160′ therebetween rear face 156′ and sidewall 60 illustrated in FIG. 15, FIG. 16, FIG. 17, and FIG. 18.

Upper ends 152 and 152′ of fingers 151 and 151′ are formed with out turned portions 152A and 152A′. Out turned portions 152A and 152A′ are out turned with respect to notches 154 and 154′, respectively. Fingers 151 and 151′ are flexurally resilient in reciprocal directions relative to sidewall 60 of rim cover 141, each as indicated by a double arrowed line E in FIG. 14, FIG. 15, FIG. 16, FIG. 17, and FIG. 18, and are flexurally resilient in reciprocal directions substantially relative to each other, each as indicated by a double arrowed line F in FIG. 14, FIG. 15, FIG. 16, FIG. 18, and FIG. 19.

Referencing FIG. 19, fingers 151 and 151′ are located between heads 56 of screws 55, and heads 56 of screws 55 reside on either side of fingers 151 and 151′ of clamp 150, and reside within and are held within the notches 154 and 154′ in fingers 151 and 151′ of clamp 150 when hanger assembly 20 is assembled and secured to an overhead support member, in which notches 154 and 154′ are applied against inner sides 56B of the heads 56 of the respective screws 55. Accordingly, rim cover 141 is received is clamp engagement with heads 56 of screws 55 to secure rim cover 141 with respect to canopy 23. Fingers 151 and 151′ are spaced apart with respect to each other, and are positioned to correspond to the positioning of the heads 56 of the respective two screws 55 securing canopy 23 to hanger bracket 21, and are aligned with the heads 56 of the respective two screws 55 when fitting rim cover 141 about the upper rim 51 of canopy 23. The integral formation of sidewall 60 with lower ends 153 and 153′ of fingers 151 and 151′ supporting notches 154 and 154′ is preferred, but it will be understood that lower ends 153 and 153′ of fingers 151 and 151′ can be welded to sidewall 60, adhesively affixed to sidewall 60, or rigidly affixed to sidewall 60 in other ways.

FIG. 19 illustrate the heads 56 of the two screws 55 positioned on either side of fingers 151 and 151′, with fingers 151 and 151′ positioned between heads 56, and the inner sides 56BA of the heads 56 of the respective two screws positioned in or otherwise received by notches 154 and 154′ formed in the respective fingers 151 and 151′ engaging and embracing heads 56. FIG. 18 is an enlarged view illustrating head 56 of screw 55 located in notch 154 formed in finger 151. The flexural nature of fingers 151 and 151′ is thus provided in such a way that fingers 151 and 151′ bias away from each other and toward the inner sides 56B of the respective heads 56 biasing notches 154 and 154′ toward and against the inner sides 56B of the respective heads 56 when installed therewith for providing a clamping engagement or embracement of heads 56 by fingers 151 and 151′ located between heads 56, according to the principle of the invention. When rim cover 24 is clamp engaged with respect to upper rim 51 of canopy 23 such that clamps 150 are clamp engaged to the heads 56 of two screws 55, fingers 151 and 151′ of the clamp 150 are received in juxtaposition with respect to upper rim 51 of canopy 23 as illustrated in FIG. 15. This aspect is also illustrated in FIG. 17, which shows finger 151′ of clamp 150 clamp engaged to head 56 of screw 55, and finger 151′ of clamp 150 received in juxtaposition with respect to upper rim 51 of canopy 23.

Fingers 151 and 151′ of each clamp 150 are flexurally resilient in reciprocal directions to concurrently admit heads 56 of screws 55 on either side of fingers 151 and 151′ and into notches 154 and 154′ formed in fingers 151 and 151′, respectively, to embrace and secure heads 56 of screws 55. The flexural character of fingers 151 and 151′ allow them to flex inwardly and toward each other as needed for installing rim cover 141 to canopy 23 and removing rim cover 141 from canopy 141. Rim cover 141 is brought upwardly toward upper rim 51 of canopy 23 and is maneuvered to register fingers 151 and 151′ with the respective heads 56 of screws 55. The heads 56 of the respective screws 55 are initially received against out turned portions 152A and 152A′ of the respective fingers 151 and 151′ . Through the application of an upward force, heads 56 of the respective screws 55 act on out turned portions 152A and 152A′ of fingers 151 and 151′, respectively, spreading fingers 151 and 151′ inwardly toward each other permitting the heads 56 of the respective screws 55 to pass between fingers 151 and 151′ to notches 154 and 154′, in which fingers 151 and 151′ then flex outwardly with respect to each other toward the inner sides 56B of the heads 56 of the respective screws 55 engaging notches 154 and 154′ of fingers 141 against the inner sides 56B of the heads 56 of the respective screws 55 clamping and embracing heads 56 on either side of fingers 151 and 151′ thereby clamping and securing heads 56 and clamp securing rim cover 141 with respect to upper rim 51 of canopy 23.

Like hanger assembly 20 illustrated in FIG. 2, when hanger assembly 140 is assembled and installed, upper edge 61 of rim cover 141 resides in juxtaposition with the ceiling. Further, lower edge 62 of rim cover 141 is in turned to reside in juxtaposition with canopy 141 as illustrated in FIG. 17.

Those of ordinary skill will readily appreciate that hanger assembly 140 may incorporate any number of screws 55 to secure canopy 23 to hanger bracket 21, and that rim cover 141 may be constructed with the appropriate number of clamps 150 to correspond the number of screws 55 hanger assembly 100 utilizes, with the understanding that each clamp 150 relates to two heads of two screws.

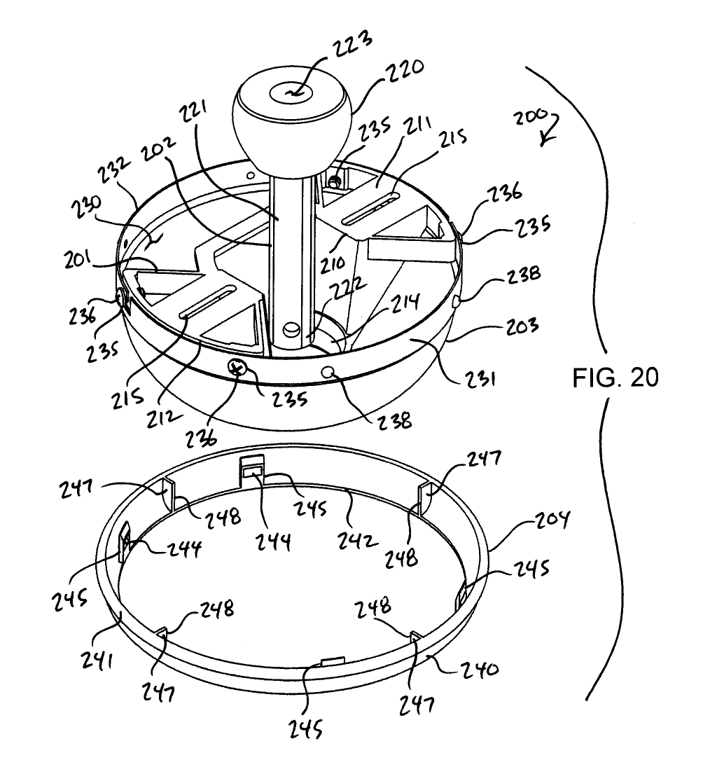

Reference is now directed to FIG. 20, in which there is seen a ceiling fan hanger assembly, incorporating the teachings of the instant invention and generally designated by reference character 200. Hanger assembly 200 includes hanger bracket 201, down rod 202, canopy 203, and rim cover 204.

Hanger bracket 201 includes base 210, upper surface 211 and peripheral sidewall 212. Spherical ball socket 214 is formed into bracket 201 at a generally central location. Slots 215 extending through base 210 accommodate mounting screws which pass through slots 215 and threadedly engage an overhead support member. Although the overhead support member is not specifically illustrated in connection with hanger assembly 200, those skilled in the art will readily appreciate that conventional overhead support members include electrical junction boxes, especially devised struts and beams, all of which are considered to be integral with a ceiling. Further, when hanger bracket 201 is secured to the overhead support member, upper surface 211 abuts the ceiling.

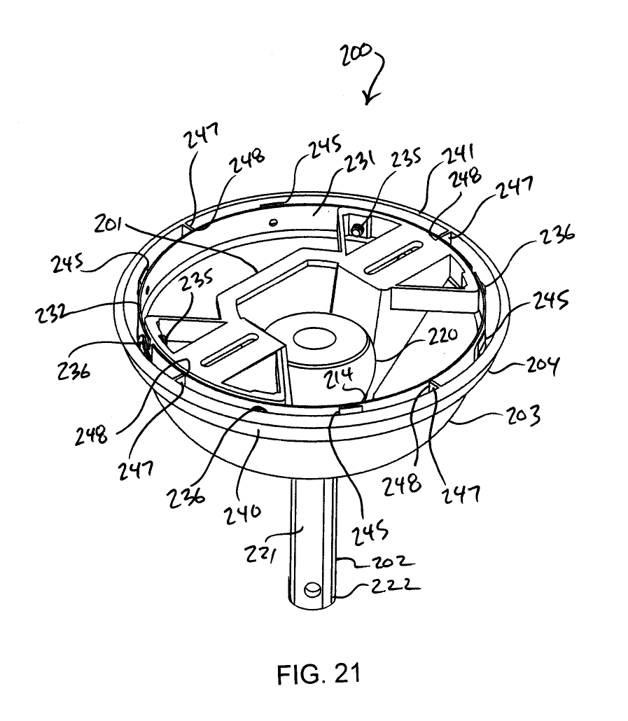

Down rod 202 includes ball 220 which is to be matingly received within socket 214 in a conventional manner. Shaft 221, having lower end 222, depends from ball 220. It will be readily understood by those skilled in the art that the lower terminal portion of shaft 221 adjacent to lower end 222 can be threaded or otherwise configured for securement to a conventional ceiling fan. Bore 223 extending longitudinally through ball 220 and shaft 221 accommodate the electrical wires which extend from a junction box to the fan. Canopy 203 is generally in the shape of an inverted dome as illustrated in FIG. 20 and FIG. 21. Referencing FIG. 20, canopy 203 includes a generally central opening 230 for receiving shaft 221 there through. Canopy 203 also includes an upper rim 231, having an upper marginal edge 232, sized and shaped to receive peripheral sidewall 212 of hanger bracket 201 therein.

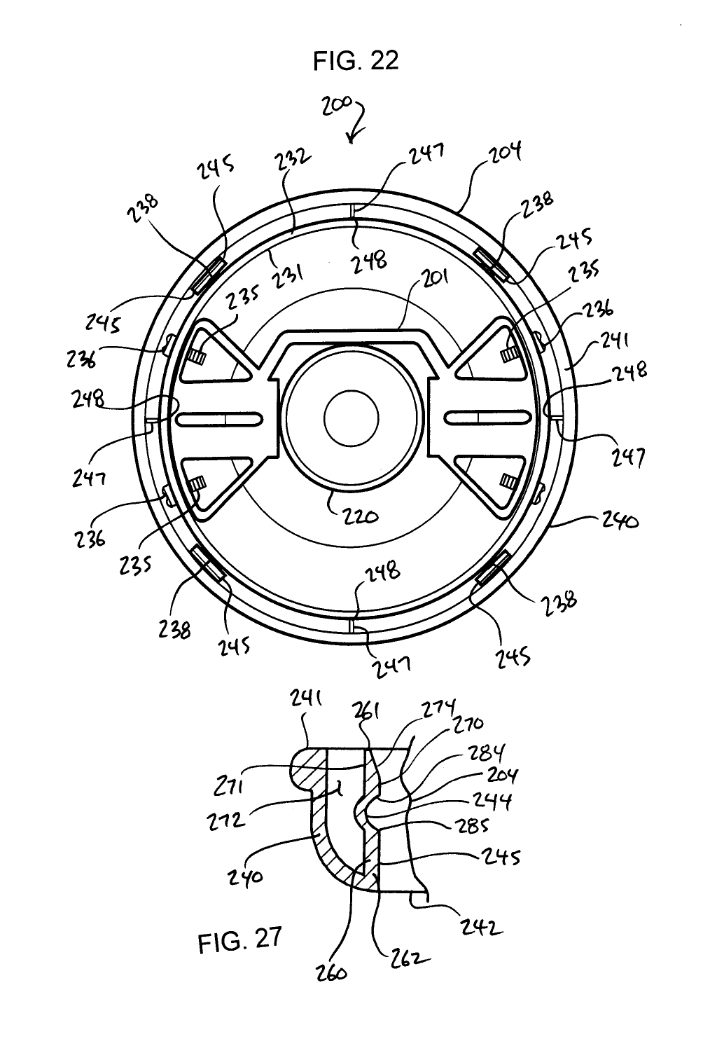

A plurality of openings extend through upper rim 231 of canopy 203, which are spaced to align with threaded bores in hanger bracket 221. A screw 235 extends through each of the openings through upper rim 231 and threadedly engages a respective threaded bore in peripheral sidewall 212 of hanger bracket 221. As illustrated in FIG. 20 and FIG. 22, a head 236 of each respective screw 235 resides externally of upper rim 231 of canopy 203. A plurality of circumferentially spaced apart protrusions 238 are formed into upper rim 231 of canopy 203.

Rim cover 204, illustrated in further detail in FIG. 21 and FIG. 22, is generally circular in shape and includes sidewall 240 having upper edge 241 and lower edge 242 and which is sized to extend about and encapsulate heads 236 of screws 235. A plurality of circumferentially spaced apart indentations 244 projects inwardly with respect to sidewall 240, and are positioned to relate to the respective protrusions 238. Preferably, the indentations 244 each have a base 245 which is integrally formed with sidewall 240. The integral formation of sidewall 240 with bases 245 supporting indentations 244 is preferred, but it will be understood that bases 245 can be welded to sidewall 240, adhesively affixed to sidewall 240, or rigidly affixed to sidewall 240 in other ways. Furthermore, indentations 244 are each preferably integrally formed with its respective base 245.

A plurality of circumferentially spaced apart spacers 247 project inwardly from sidewall 240 and each terminate with an inwardly directed edge 248. Spacers 247 are substantially equal in size and shape, and are spaced apart with respect to indentations 244. Preferably, spacers 247 are integrally formed with sidewall 240. The integral formation of sidewall 240 with spacers 247 is preferred, but it will be understood that spacers 247 can be welded to sidewall 240, adhesively affixed to sidewall 240, or rigidly affixed to sidewall 240 in other ways. Furthermore, indentations 244 are each preferably integrally formed with its respective base 245.

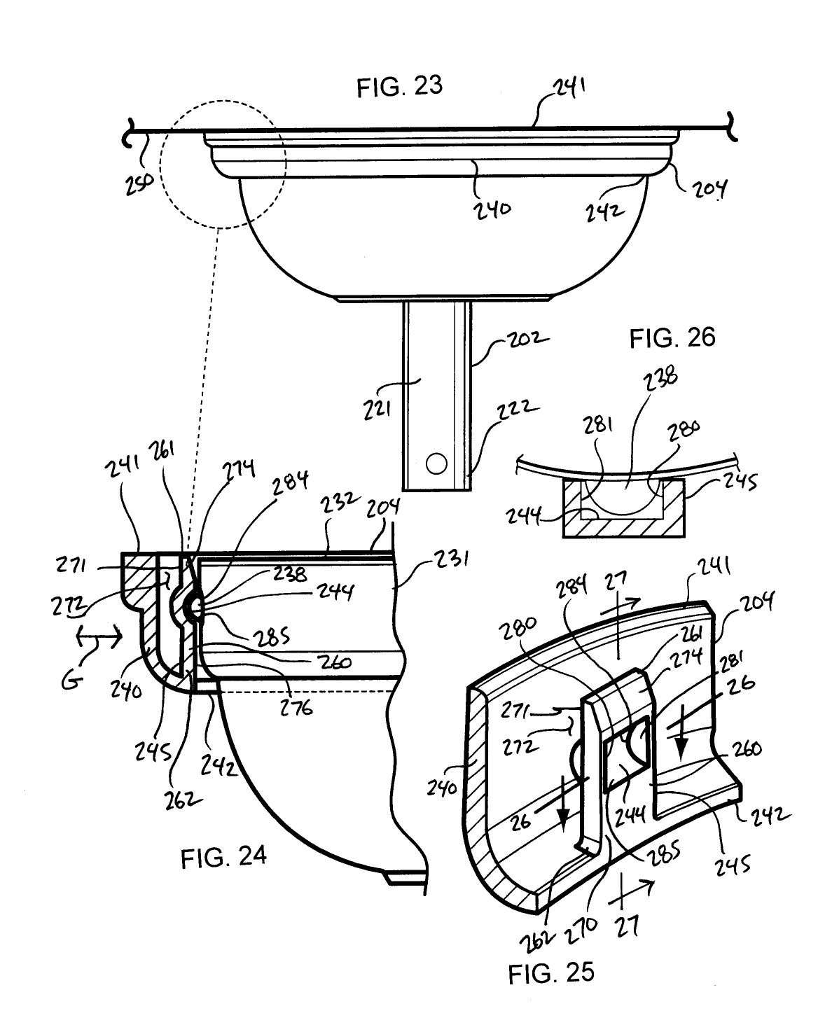

Looking to FIG. 24, each indentation 244 relates to and matingly receives therein or otherwise accepts a respective protrusion 238 when hanger assembly 200 is assembled and secured to an overhead support member. Each protrusion 245 and corresponding indentation 244 pair form an engagement pair, in which one is an element of the engagement pair and the other is the corresponding or complemental element of the engagement pair. Accordingly, rim cover 204 is received in snap engagement with canopy 203. As further seen in FIG. 23, when the hanger assembly 200 is assembled and installed, the upper edge 241 of rim cover 204 resides in juxtaposition with ceiling 250, and lower edge 242 of rim cover 204 is in turned to reside in juxtaposition with canopy 203, which is also shown in FIG. 24. Spacers 247 carried by rim cover 204 are positioned between rim cover 204 of upper rim 231 of canopy 203 and edges 248 of spacers 247 are received in juxtaposition with respect to upper rim 231 of canopy 203, whereby spacers 247 interact between upper rim 231 of canopy 203 and rim cover 204 to set rim cover 204 at a substantially fixed circumferential spacing relative to upper rim 231 of canopy 203 as shown in FIG. 22.

Referencing FIG. 25 and FIG. 27, each base 245 consists of an upstanding finger 260. Finger 260 has an upper end 261 and an opposing lower end 262 affixed to sidewall 240 of rim cover 204 at lower edge 242. Finger 260 projects upwardly from lower edge 242 and terminates with upper end 261, which is directed toward upper edge 241. Finger 260 has a front face 270 into which indentation 244 is formed, and an opposing rear face 271 facing sidewall 240, and there is a gap 272 therebetween. A beveled surface 274 is formed in front face 270 of finger 260 proximate to upper end 261 of finger 260. Indentation 244 is formed in front face 270 of finger 260, and is located between beveled surface 274 and lower end 262. Finger 260 is flexible, and flexes in reciprocal directions relative to sidewall 240 as indicated by the double arrowed line G in FIG. 24. The flexural character of finger 260 allows it to flex as needed for installing rim cover 204 to canopy 203 and removing rim cover 204 from canopy 203. FIG. 24 illustrates protrusion 238 as it would appear received by and engaging indentation 244 formed in front face 270 of finger 260. The flexural nature of finger 260 is also provided in such a way that finger 260 biases indentation 244 toward and against protrusion 238 when installed therewith for providing a rugged and forcible engagement of protrusion 238 in and against indentation 244. Preferably, lower end 262 of finger 260 is integrally formed with sidewall 240. The integral formation of lower end 262 of finger 260 with sidewall 240 is preferred, but it will be understood that lower end 262 can be welded to sidewall 240, adhesively affixed to sidewall 240, or rigidly affixed to sidewall 240 in other ways.

To install rim cover 204, rim cover 204 is brought upwardly toward upper rim 231 of canopy 203 and is maneuvered to register fingers 260 with the respective protrusions 238. With respect to each finger 260, beveled surface 274 is initially received against a corresponding protrusion 238 of canopy 203. Through the application of an upward force, protrusion 238 acts on beveled surface 274 deflecting finger 260 outwardly toward sidewall 240 permitting protrusion 238 to encounter indentation 244 and finger 260 then deflects away from sidewall 240 toward protrusion 238 snap receiving protrusion 238 within indentation 244 securing rim cover 204 with respect to upper rim 231 of canopy 203.

Indentation 244 is bound on either side by opposed, substantially parallel sidewalls 280 and 281 shown in FIG. 25 and in FIG. 26, and is bound on either end by opposed, substantially parallel top and bottom walls 284 and 285 shown in FIG. 24 and in FIG. 25, which extend between sidewalls 280 and 281. Indentation 244 is sized to receive a protrusion 238, opposed sidewalls 280 and 281 interact with the protrusion 238 on either side of protrusion 238 as shown in FIG. 26 to constrain or otherwise prevent rim cover 204 from horizontally displacing with respect to canopy 203, and top and bottom walls 284 and 285 interact with the protrusion 238 along the top and bottom of protrusion 238 as shown in FIG. 24 to constrain or otherwise prevent rim cover 204 from vertically displacing with respect to canopy 203.

In the preferred embodiment of hanger assembly 200, indentation 244 of each engagement pair is carried by finger 260 and the corresponding protrusion 238 is carried by canopy 203. If desired, this arrangement can be reversed.

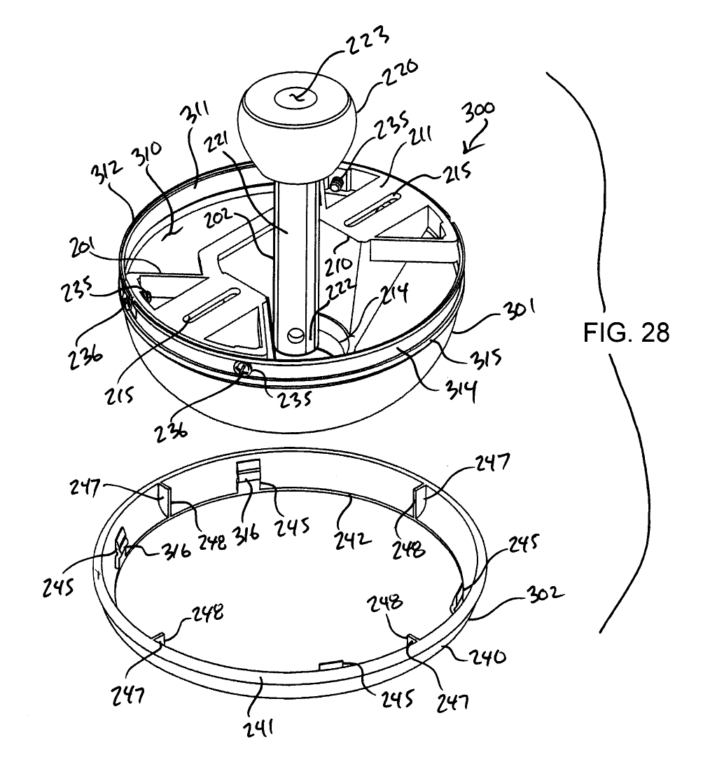

Reference is now directed to FIG. 28, in which there is seen a ceiling fan hanger assembly, incorporating the teachings of the instant invention and generally designated by reference character 300. In common with hanger assembly 200, hanger assembly 300 shares hanger bracket 201, down rod 202, and incorporates an alternate embodiment of a canopy denoted at 301, and an alternate embodiment of a rim cover denoted at 302.

Hanger bracket 201 includes base 210, upper surface 211 and peripheral sidewall 212, spherical ball socket 214, and slots 215 extending through base 210 accommodate mounting screws which pass through slots 215 and threadedly engage an overhead support member. Down rod 202 includes ball 220 which is to be matingly received within socket 214. Shaft 221, having lower end 222, depends from ball 220, and the lower terminal portion of shaft 221 adjacent to lower end 222 can be threaded or otherwise configured for securement to a conventional ceiling fan. Bore 223 extends longitudinally through ball 220 and shaft 221 and accommodates the electrical wires which extend from a junction box to the fan.

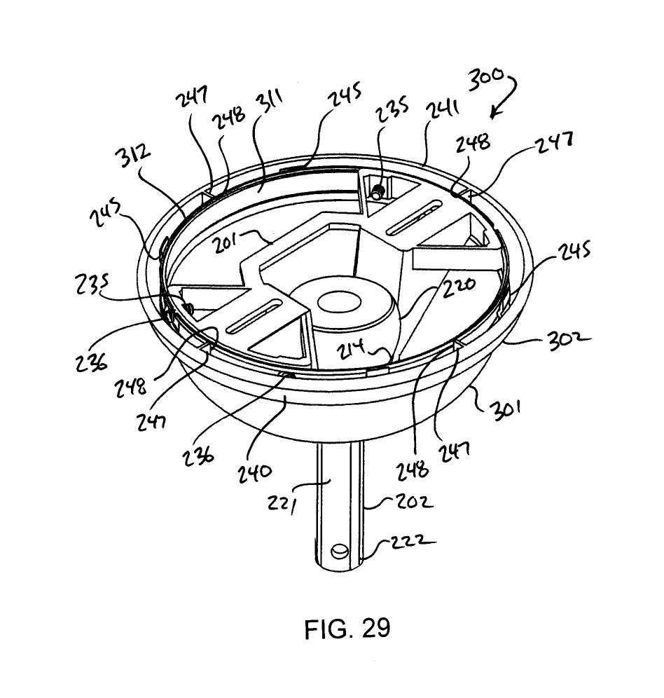

Canopy 301 is generally in the shape of an inverted dome as illustrated in FIG. 28 and FIG. 29. Referencing FIG. 28, canopy 301 includes a generally central opening 310 for receiving shaft 221 there through. Canopy 301 also includes an upper rim 311, having an upper marginal edge 312, sized and shaped to receive peripheral sidewall 212 of hanger bracket 201 therein.

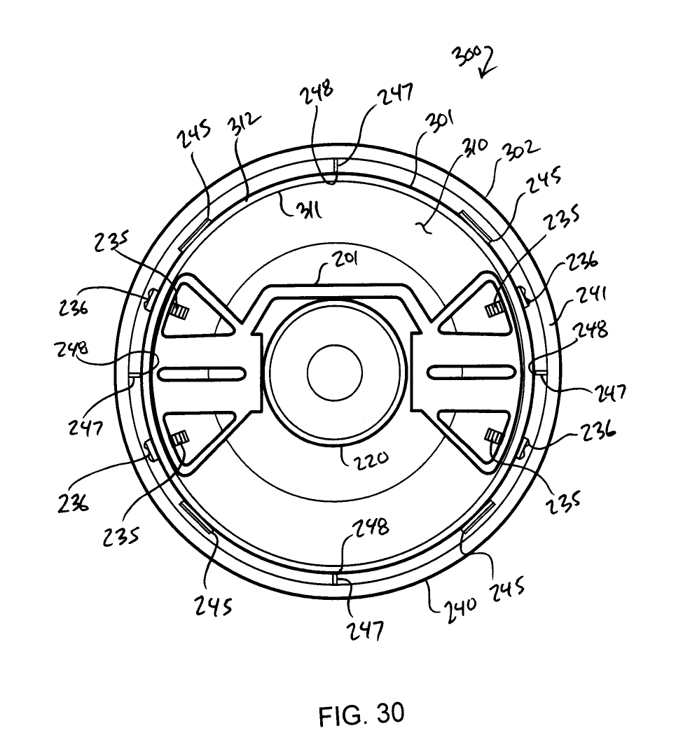

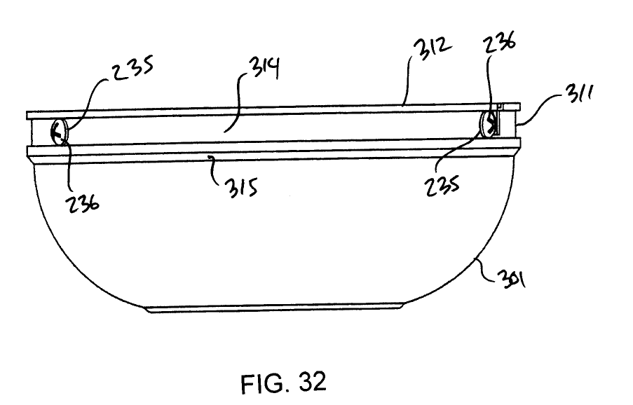

A plurality of openings extend through upper rim 311 of canopy 301, which are spaced to align with threaded bores in hanger bracket 221. Screw 235 extends through each of the openings through upper rim 311 and threadedly engages a respective threaded bore in peripheral sidewall 212 of hanger bracket 221. As illustrated in FIG. 28 and FIG. 30, head 236 of each respective screw 235 resides externally of upper rim 311 of canopy 301. According to the principle of the invention, a circumferential continuous groove 314 is formed into upper rim 311 of canopy 301, as illustrated in FIG. 28 and FIG. 32. Heads 236 of screws 235 each reside external of the upper rim 311 of canopy 301 within continuous groove 314, and rim cover 302 is for encapsulating heads 236 of screws 235 located in continuous groove 314 and is securable with respect to upper rim 311 of canopy 301. A continuous, parametric rim or abutment 315 is formed in canopy 301 proximate to upper rim 311, projects outward with respect to canopy 301, and is positioned underneath groove 314.

Rim cover 302, illustrated in further detail in FIG. 29 and FIG. 30, is generally circular in shape and includes sidewall 240 having upper edge 241 and lower edge 242 and which is sized to extend about and encapsulate heads 236 of screws 235 residing in continuous groove 314. A plurality of circumferentially spaced apart protrusions 316 projects inwardly from sidewall 240, and are positioned to relate to continuous groove 314. Preferably, the protrusions 316 each have base 245 which is integrally formed with sidewall 240. The integral formation of sidewall 240 with bases 245 supporting protrusions 316 is preferred, but it will be understood that bases 245 can be welded to sidewall 240, adhesively affixed to sidewall 240, or rigidly affixed to sidewall 240 in other ways. Furthermore, protrusions 316 are each preferably integrally formed with its respective base 245.

Spacers 247 project inwardly from sidewall 240 and each terminate with inwardly directed edge 248. Spacers 247 are substantially equal in size and shape, and are preferably integrally formed with sidewall 240. The integral formation of sidewall 240 with spacers 247 is preferred, but it will be understood that spacers 247 can be welded to sidewall 240, adhesively affixed to sidewall 240, or rigidly affixed to sidewall 240 in other ways. Furthermore, protrusions 316 are each preferably integrally formed with its respective base 245.

Referencing FIG. 33, each protrusion 316 is received by and into continuous groove 314 when hanger assembly 300 is assembled and secured to an overhead support member securing and suspending rim cover 302 with respect to canopy 301. Groove 314 and each protrusion 316 form an engagement pair, in which one is an element of the engagement pair and the other is the corresponding or complemental element of the engagement pair.

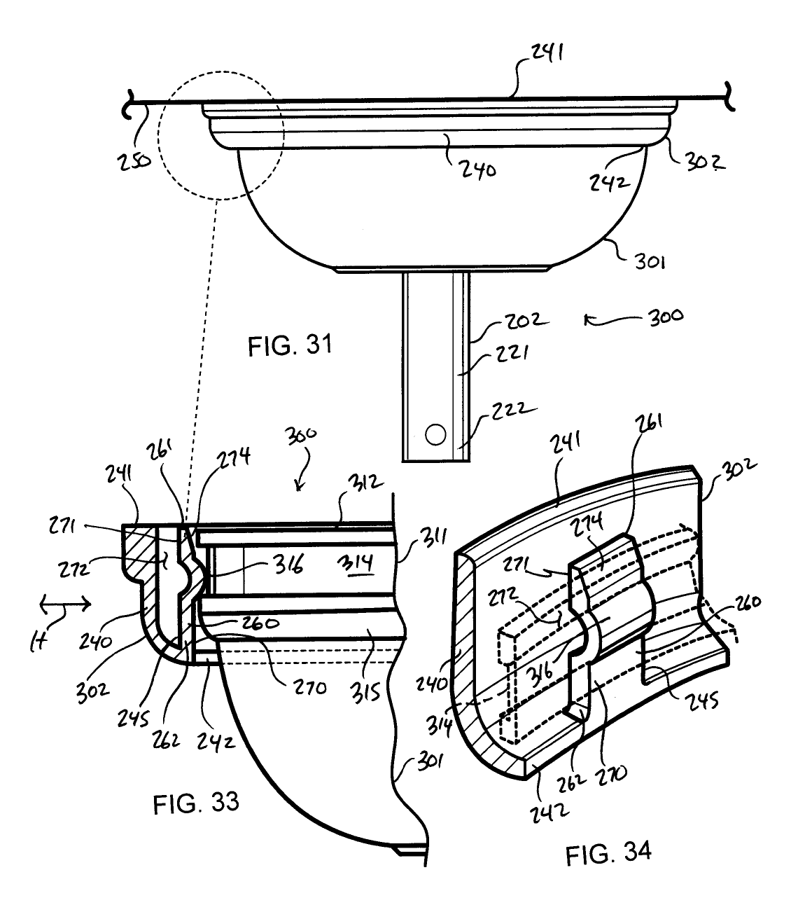

The continuous groove 314 and each protrusion 316 are an engagement pair. Accordingly, rim cover 302 is received in snap engagement with canopy 301. As further seen in FIG. 31, when the hanger assembly 300 is assembled and installed, the upper edge 241 of rim cover 302 resides in juxtaposition with ceiling 250, and lower edge 242 of rim cover 302 is in turned to reside in juxtaposition with canopy 301, which is also shown in FIG. 33. Spacers 247 carried by rim cover 302 are positioned between rim cover 302 of upper rim 311 of canopy 301 and edges 248 of spacers 247 are received in juxtaposition with respect to upper rim 311 of canopy 301, whereby spacers 247 interact between upper rim 311 of canopy 301 and rim cover 302 to set rim cover 302 at a substantially fixed circumferential spacing relative to upper rim 311 of canopy 301 as shown in FIG. 30.

Referencing FIG. 34, each base 245 consists of upstanding finger 260. Finger 260 has upper end 261 and opposing lower end 262 affixed to sidewall 240 of rim cover 302 at lower edge 242. Finger 260 projects upwardly from lower edge 242 and terminates with upper end 261, which is directed toward upper edge 241. Finger 260 has front face 270 formed with protrusion 316, and opposing rear face 271 facing sidewall 240, and there is a gap 272 therebetween. Beveled surface 274 is formed in front face 270 of finger 260 proximate to upper end 261 of finger 260. Protrusion 316 is formed in front face 270 of finger 260, and is located between beveled surface 274 and lower end 262. Finger 260 is flexible, and flexes in reciprocal directions relative to sidewall 240 as indicated by the double arrowed line H in FIG. 33. The flexural character of finger 260 allows it to flex as needed for installing rim cover 302 to canopy 301 and removing rim cover 302 from canopy 301. FIG. 33 illustrates protrusion 316 as it would appear received by and engaging groove 314 formed in upper rim 311 of canopy 30. The flexural nature of finger 260 is also provided in such a way that finger 260 biases protrusion 316 toward and against continuous groove 314 when installed therewith for providing a rugged and forcible engagement of protrusion 316 in and against groove 314. Preferably, lower end 262 of finger 260 is integrally formed with sidewall 240. The integral formation of lower end 262 of finger 260 with sidewall 240 is preferred, but it will be understood that lower end 262 can be welded to sidewall 240, adhesively affixed to sidewall 240, or rigidly affixed to sidewall 240 in other ways.

To install rim cover 302 in the present embodiment, rim cover 302 is brought upwardly toward upper rim 311 of canopy 301 and is maneuvered to register fingers 260 with groove 314. With respect to each finger 260, beveled surface 274 is initially received against abutment 315 of canopy 301. Through the application of an upward force, abutment 315 acts on beveled surface 274 deflecting finger 260 away from canopy 301 toward sidewall 240 permitting protrusion 316 to encounter groove 314 and finger 260 then deflects away from sidewall 240 toward groove 314 snap receiving protrusion 316 within groove 314 engaging protrusion 316 with groove 314 suspending and securing rim cover 302 with respect to upper rim 311 of canopy 301.

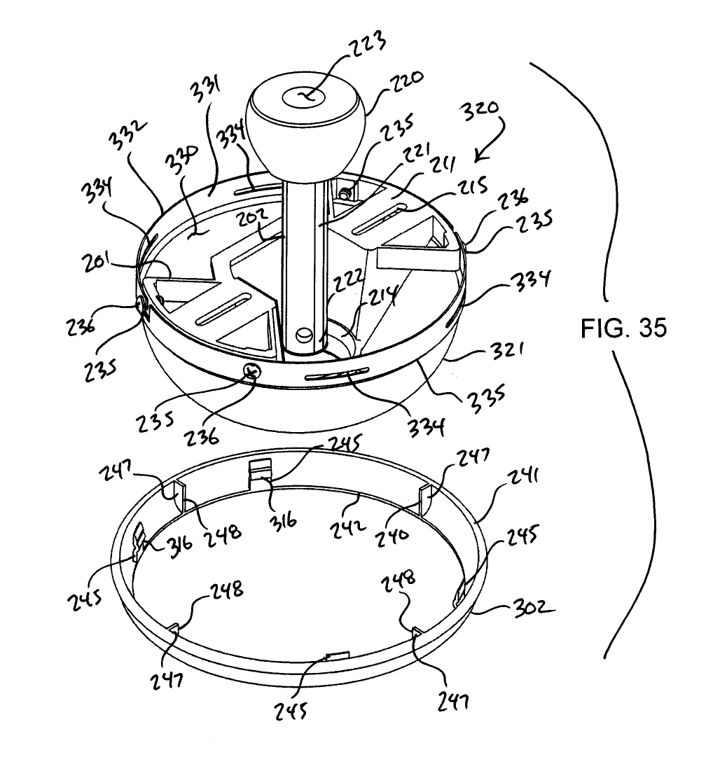

Reference is now directed to FIG. 35, in which there is seen a ceiling fan hanger assembly, incorporating the teachings of the instant invention and generally designated by reference character 320. In common with hanger assembly 300, hanger assembly 320 shares hanger bracket 201, down rod 202, and rim cover 302, and incorporates an alternate embodiment of a canopy denoted at 321.

Hanger bracket 201 includes base 210, upper surface 211 and peripheral sidewall 212, spherical ball socket 214, and slots 215 extending through base 210 accommodate mounting screws which pass through slots 215 and threadedly engage an overhead support member. Down rod 202 includes ball 220 which is to be matingly received within socket 214. Shaft 221, having lower end 222, depends from ball 220, and the lower terminal portion of shaft 221 adjacent to lower end 222 can be threaded or otherwise configured for securement to a conventional ceiling fan. Bore 223 extends longitudinally through ball 220 and shaft 221 and accommodates the electrical wires which extend from a junction box to the fan.

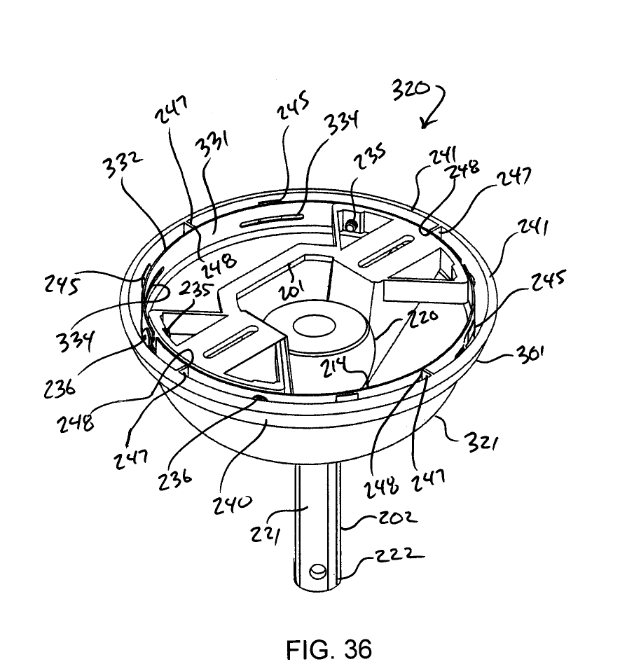

Canopy 321 is generally in the shape of an inverted dome as illustrated in FIG. 35 and FIG. 36. Referencing FIG. 35, canopy 321 includes a generally central opening 330 for receiving shaft 221 there through. Canopy 321 also includes an upper rim 331, having an upper marginal edge 332, sized and shaped to receive peripheral sidewall 212 of hanger bracket 201 therein.

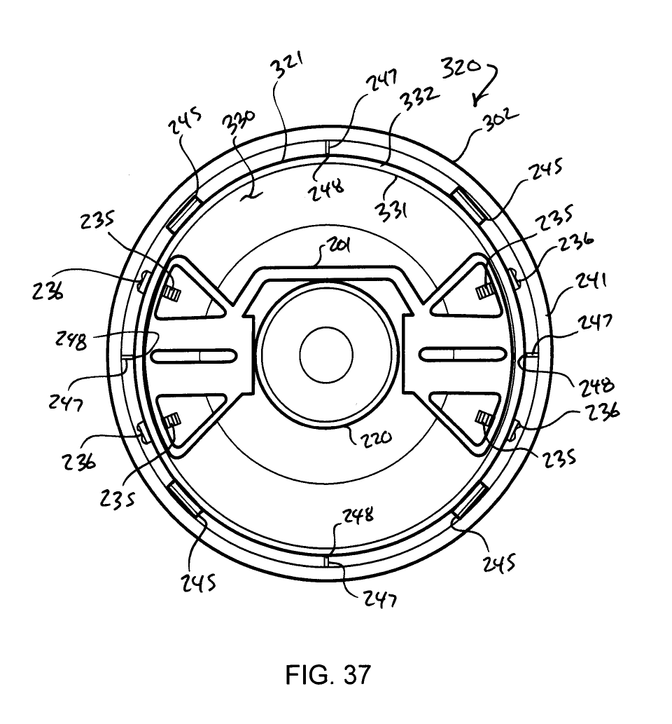

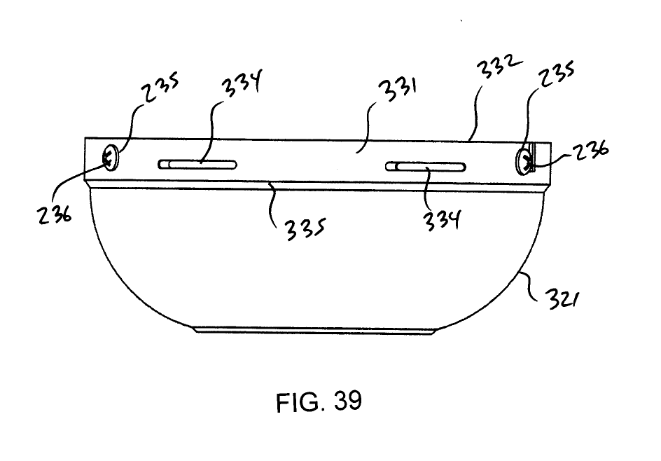

A plurality of openings extend through upper rim 331 of canopy 321, which are spaced to align with threaded bores in hanger bracket 221. Screw 235 extends through each of the openings through upper rim 331 and threadedly engages a respective threaded bore in peripheral sidewall 212 of hanger bracket 221. As illustrated in FIG. 35 and FIG. 37, head 236 of each respective screw 235 resides externally of upper rim 331 of canopy 321. A plurality of circumferentially spaced apart slots 334 is formed into upper rim 331 of canopy 321. Slots 334 in canopy 331, which are also shown in FIG. 39, extend through upper rim 331 of canopy 321, and are each circumferentially elongate. A continuous, parametric rim or abutment 335 is formed in canopy 321 proximate to upper rim 331, projects outward with respect to canopy 321, and is positioned underneath slots 334.

Rim cover 302, illustrated in further detail in FIG. 36 and FIG. 37, is generally circular in shape and includes sidewall 240 having upper edge 241 and lower edge 242 and which is sized to extend about and encapsulate heads 236 of screws 235. The plurality of circumferentially spaced apart protrusions 316 project inwardly from sidewall 240, and are each positioned to relate to a slot 334. Preferably, the protrusions 316 each have base 245 which is integrally formed with sidewall 240. The integral formation of sidewall 240 with bases 245 supporting protrusions 316 is preferred, but it will be understood that bases 245 can be welded to sidewall 240, adhesively affixed to sidewall 240, or rigidly affixed to sidewall 240 in other ways. Furthermore, protrusions 316 are each preferably integrally formed with its respective base 245.

Spacers 247 project inwardly from sidewall 240 and each terminate with inwardly directed edge 248. Spacers 247 are substantially equal in size and shape, and are preferably integrally formed with sidewall 240. The integral formation of sidewall 240 with spacers 247 is preferred, but it will be understood that spacers 247 can be welded to sidewall 240, adhesively affixed to sidewall 240, or rigidly affixed to sidewall 240 in other ways. Furthermore, protrusions 316 are each preferably integrally formed with its respective base 245.

Looking to FIG. 40, each protrusion 316 is received by and within a corresponding slot 334 when hanger assembly 320 is assembled and secured to an overhead support member. Each protrusion 316 and corresponding slot 334 pair form an engagement pair, in which one is an element of the engagement pair and the other is the corresponding or complemental element of the engagement pair. Accordingly, rim cover 302 is received in snap engagement with canopy 321. Preferably, each slot 334 is circumferentially elongate thereby eliminating the necessity of precise alignment when fitting rim cover 302 about upper rim 331 of canopy 321.

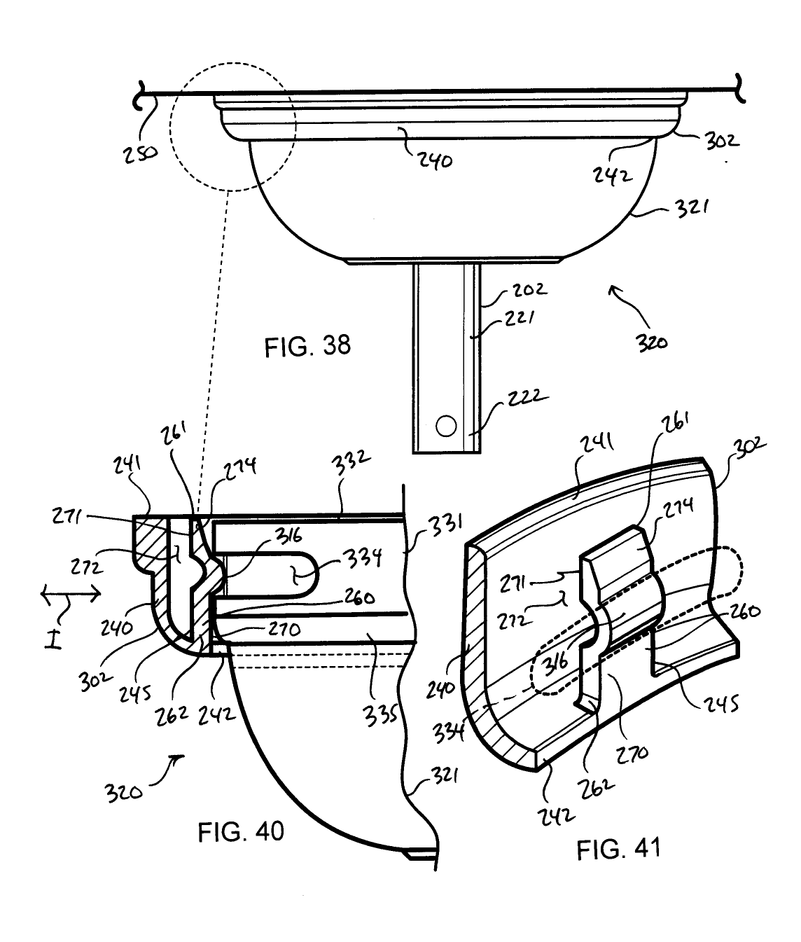

As further seen in FIG. 38, when the hanger assembly 320 is assembled and installed, the upper edge 241 of rim cover 302 resides in juxtaposition with ceiling 250, and lower edge 242 of rim cover 302 is in turned to reside in juxtaposition with canopy 321, which is also shown in FIG. 40. Spacers 247 carried by rim cover 302 are positioned between rim cover 302 of upper rim 331 of canopy 321 and edges 248 of spacers 247 are received in juxtaposition with respect to upper rim 331 of canopy 321, whereby spacers 247 interact between upper rim 331 of canopy 321 and rim cover 302 to set rim cover 302 at a substantially fixed circumferential spacing relative to upper rim 331 of canopy 321 as shown in FIG. 37.

Referencing FIG. 41, each base 245 consists of upstanding finger 260. Finger 260 has upper end 261 and opposing lower end 262 affixed to sidewall 240 of rim cover 302 at lower edge 242. Finger 260 projects upwardly from lower edge 242 and terminates with upper end 261, which is directed toward upper edge 241. Finger 260 has front face 270 formed with protrusion 316, and an opposing rear face 271 facing sidewall 240, and there is a gap 272 therebetween. Beveled surface 274 is formed in front face 270 of finger 260 proximate to upper end 261 of finger 260. Protrusion 316 is formed in front face 270 of finger 260, and is located between beveled surface 274 and lower end 262. Finger 260 is flexible, and flexes in reciprocal directions relative to sidewall 240 as indicated by the double arrowed line I in FIG. 40. The flexural character of finger 260 allows it to flex as needed for installing rim cover 302 to canopy 321 and removing rim cover 302 from canopy 321. FIG. 40 illustrates protrusion 316 as it would appear received by, extending through, and engaging slot 334 formed in upper rim 331 of canopy 30. The flexural nature of finger 260 is also provided in such a way that finger 260 biases protrusion 316 toward and into and through slot 334 when installed therewith for providing a rugged and forcible engagement of protrusion 316 in, to, and through slot 334. Preferably, lower end 262 of finger 260 is integrally formed with sidewall 240. The integral formation of lower end 262 of finger 260 with sidewall 240 is preferred, but it will be understood that lower end 262 can be welded to sidewall 240, adhesively affixed to sidewall 240, or rigidly affixed to sidewall 240 in other ways.

To install rim cover 302 in the present embodiment, rim cover 302 is brought upwardly toward upper rim 331 of canopy 321 and is maneuvered to register fingers 260 with slots 334. With respect to each finger 260, beveled surface 274 is initially received against abutment 335 of canopy 321. Through the application of an upward force, abutment 335 acts on beveled surface 274 deflecting finger 260 outwardly away from canopy 321 toward sidewall 240 permitting protrusion 316 to encounter a corresponding slot 334, at which point finger 260 then deflects away from sidewall 240 toward slot 334 in canopy 321 snap receiving protrusion 316 within and into and through slot 334 suspending and securing rim cover 302 with respect to upper rim 331 of canopy 321.

In the preferred embodiment of hanger assembly 320, protrusion 316 of each engagement pair is carried by finger 260 and the corresponding slot 334 is carried by canopy 321. If desired, this arrangement can be reversed.

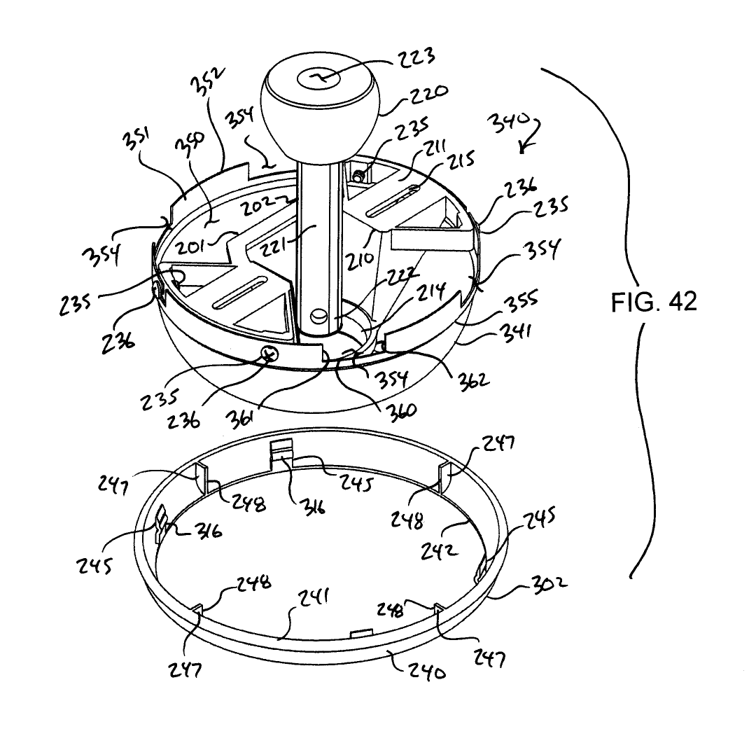

Reference is now directed to FIG. 42, in which there is seen a ceiling fan hanger assembly, incorporating the teachings of the instant invention and generally designated by reference character 340. In common with hanger assembly 300, hanger assembly 340 shares hanger bracket 201, down rod 202, and rim cover 302, and incorporates an alternate embodiment of a canopy denoted at 341.

Hanger bracket 201 includes base 210, upper surface 211 and peripheral sidewall 212, spherical ball socket 214, and slots 215 extending through base 210 accommodate mounting screws which pass through slots 215 and threadedly engage an overhead support member. Down rod 202 includes ball 220 which is to be matingly received within socket 214. Shaft 221, having lower end 222, depends from ball 220, and the lower terminal portion of shaft 221 adjacent to lower end 222 can be threaded or otherwise configured for securement to a conventional ceiling fan. Bore 223 extends longitudinally through ball 220 and shaft 221 and accommodates the electrical wires which extend from a junction box to the fan.

Canopy 341 is generally in the shape of an inverted dome as illustrated in FIG. 35 and FIG. 36. Referencing FIG. 35, canopy 341 includes a generally central opening 350 for receiving shaft 221 there through. Canopy 341 also includes an upper rim 351, having an upper marginal edge 352, sized and shaped to receive peripheral sidewall 212 of hanger bracket 201 therein.

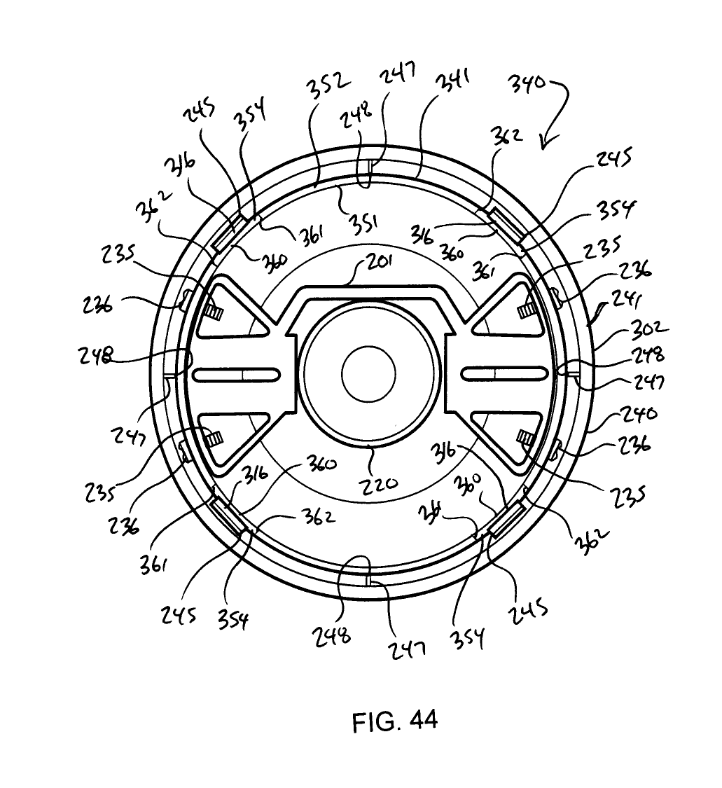

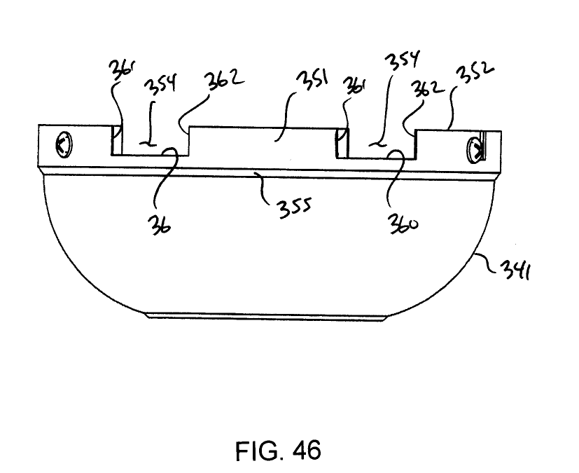

A plurality of openings extend through upper rim 351 of canopy 341, which are spaced to align with threaded bores in hanger bracket 221. Screw 235 extends through each of the openings through upper rim 351 and threadedly engages a respective threaded bore in peripheral sidewall 212 of hanger bracket 221. As illustrated in FIG. 42 and FIG. 44, head 236 of each respective screw 235 resides externally of upper rim 351 of canopy 341. A plurality of circumferentially spaced apart notches 334 is formed into upper rim 351 of canopy 341. Notches 354 in canopy 351, which are also shown in FIG. 46, extend through upper rim 351 of canopy 341, and are each circumferentially elongate. A continuous, parametric rim or abutment 335 is formed in canopy 341 proximate to upper rim 351, projects outward with respect to canopy 341, and is positioned underneath notches 354. Each notch 354 extends downwardly into upper rim 351 of canopy 341 from upper marginal edge 352 and terminates with a horizontal lower edge 360 extending between opposed vertical side edges 361 and 362 formed in canopy 341 and which cooperate to form and bound notch 354. ;

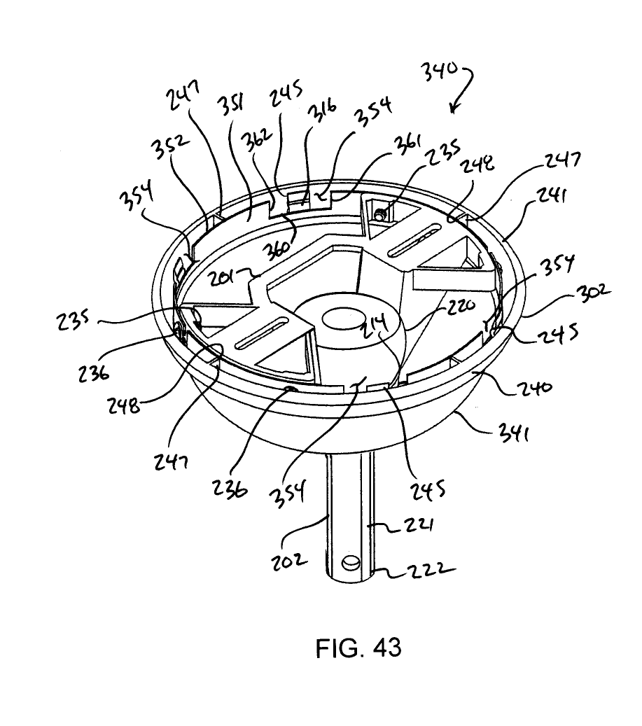

Rim cover 302, illustrated in further detail in FIG. 43 and FIG. 44, is generally circular in shape and includes sidewall 240 having upper edge 241 and lower edge 242 and which is sized to extend about and encapsulate heads 236 of screws 235. The plurality of circumferentially spaced apart protrusions 316 projects inwardly from sidewall 240, and are each positioned to relate to a notch 354. Preferably, the protrusions 316 each have base 245 which is integrally formed with sidewall 240. The integral formation of sidewall 240 with bases 245 supporting protrusions 316 is preferred, but it will be understood that bases 245 can be welded to sidewall 240, adhesively affixed to sidewall 240, or rigidly affixed to sidewall 240 in other ways. Furthermore, protrusions 316 are each preferably integrally formed with its respective base 245.

Spacers 247 project inwardly from sidewall 240 and each terminate with inwardly directed edge 248. Spacers 247 are substantially equal in size and shape, and are preferably integrally formed with sidewall 240. The integral formation of sidewall 240 with spacers 247 is preferred, but it will be understood that spacers 247 can be welded to sidewall 240, adhesively affixed to sidewall 240, or rigidly affixed to sidewall 240 in other ways. Furthermore, protrusions 316 are each preferably integrally formed with its respective base 245.

Looking to FIG. 47, each protrusion 316 is received by and a corresponding notch 354 when hanger assembly 340 is assembled and secured to an overhead support member. Each protrusion 316 and corresponding notch 354 pair form an engagement pair, in which one is an element of the engagement pair and the other is the corresponding or complemental element of the engagement pair. Accordingly, rim cover 302 is received in snap engagement with canopy 341. Preferably, each notch 354 is circumferentially elongate thereby eliminating the necessity of precise alignment when fitting rim cover 302 about upper rim 351 of canopy 341.

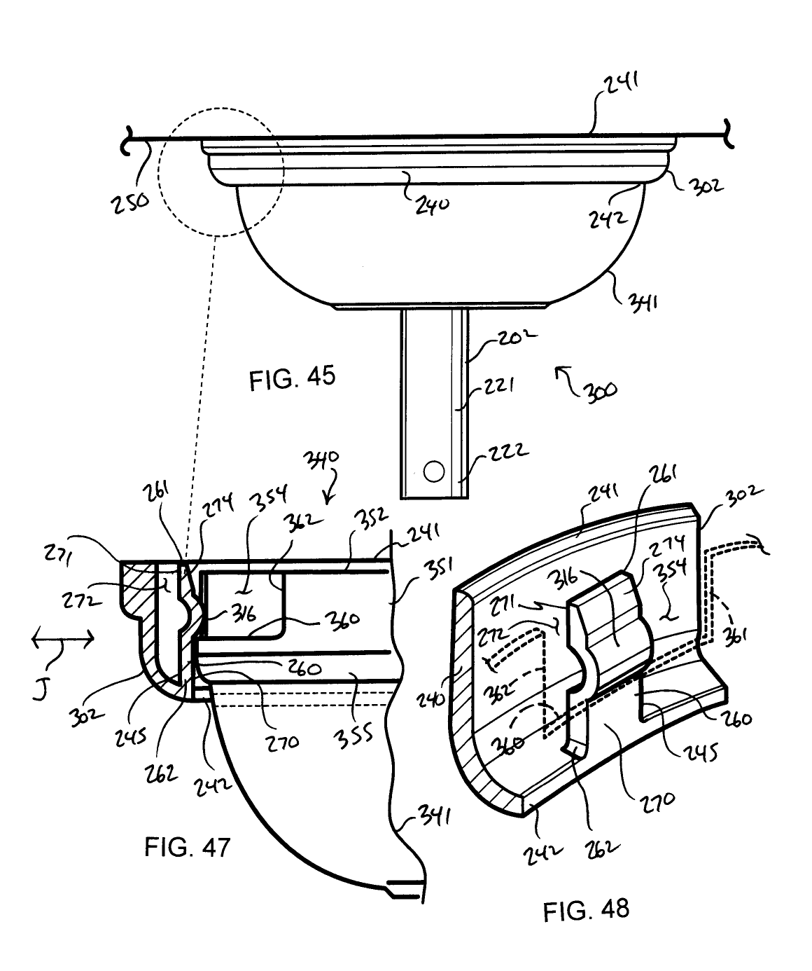

As further seen in FIG. 45, when the hanger assembly 340 is assembled and installed, the upper edge 241 of rim cover 302 resides in juxtaposition with ceiling 250, and lower edge 242 of rim cover 302 is in turned to reside in juxtaposition with canopy 341, which is also shown in FIG. 40. Spacers 247 carried by rim cover 302 are positioned between rim cover 302 of upper rim 351 of canopy 341 and edges 248 of spacers 247 are received in juxtaposition with respect to upper rim 351 of canopy 341, whereby spacers 247 interact between upper rim 351 of canopy 341 and rim cover 302 to set rim cover 302 at a substantially fixed circumferential spacing relative to upper rim 351 of canopy 341 as shown in FIG. 44.

Referencing FIG. 48, each base 245 consists of upstanding finger 260. Finger 260 has upper end 261 and opposing lower end 262 affixed to sidewall 240 of rim cover 302 at lower edge 242. Finger 260 projects upwardly from lower edge 242 and terminates with upper end 261, which is directed toward upper edge 241. Finger 260 has front face 270 formed with protrusion 316, and an opposing rear face 271 facing sidewall 240, and there is a gap 272 therebetween. Beveled surface 274 is formed in front face 270 of finger 260 proximate to upper end 261 of finger 260. Protrusion 316 is formed in front face 270 of finger 260, and is located between beveled surface 274 and lower end 262. Finger 260 is flexible, and flexes in reciprocal directions relative to sidewall 240 as indicated by the double arrowed line J in FIG. 47. The flexural character of finger 260 allows it to flex as needed for installing rim cover 302 to canopy 341 and removing rim cover 302 from canopy 341. FIG. 47 illustrates protrusion 316 as it would appear received by, extending through, and engaging notch 354 formed in upper rim 351 of canopy 30. The flexural nature of finger 260 is also provided in such a way that finger 260 biases protrusion 316 toward and into and through notch 354 when installed therewith for providing a rugged and forcible engagement of protrusion 316 in and against groove 314. Preferably, lower end 262 of finger 260 is integrally formed with sidewall 240. The integral formation of lower end 262 of finger 260 with sidewall 240 is preferred, but it will be understood that lower end 262 can be welded to sidewall 240, adhesively affixed to sidewall 240, or rigidly affixed to sidewall 240 in other ways.

To install rim cover 302, rim cover 302 is brought upwardly toward upper rim 351 of canopy 341 and is maneuvered to register fingers 260 with notches 354. With respect to each finger 260, abutment 335 is initially received against beveled surface 274. Through the application of an upward force, abutment 335 acts on beveled surface 274 deflecting finger 260 away from canopy 341 toward sidewall 240 permitting protrusion 316 to encounter a corresponding notch 354, at which point finger 260 then deflects away from sidewall 240 toward notch 354 in canopy 341 snap receiving protrusion 316 into and through notch 354 suspending and securing rim cover 302 with respect to upper rim 351 of canopy 341. Protrusion 316 is matingly receivable in notch 354 and is detachably receivable against and upon lower edge 360 of notch 354 between opposed side edges 361 and 361 to suspend rim cover 302 from canopy 341.

The present invention is described above with reference to preferred embodiments. However, those skilled in the art will recognize that changes and modifications may be made in the described embodiments without departing from the nature and scope of the present invention. For instance, while the various hanger assemblies are illustrated as circular, it is contemplated that the assemblies may assume a multi-sided or free form configurations.

Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and having an upper rim;
mounting screws each extending through the rim of the canopy and engaged to the hanger bracket and having a head residing external of the rim of the canopy;
a rim cover for encapsulating the heads of the screws and securable with respect to the rim of the canopy;
a finger having a lower end affixed to the rim cover and an opposing upper end, a front face and an opposing rear face;
a gap between the rear face of the finger and the rim cover;
the finger flexurally resilient in reciprocal directions relative to the rim cover;
a first element of an engagement pair is carried by the rim of the canopy;
a second element of the engagement pair is carried by the front face of the finger for detachable engagement with the element of the engagement pair;
one of the first and second elements comprising an indentation bound on either side by opposed, substantially parallel sidewalls, and bound on either end by opposed, substantially parallel top and bottom walls extending between the opposed sidewalls;
the other of the first and second elements comprising a protrusion receivable within the indentation; and
the opposed sidewalls and the opposed top and bottom walls to interact with the protrusion received within the indentation to constrain the rim cover from horizontal and vertical displacement with respect to the canopy.

2. The hanger assembly of claim 1, wherein:
the indentation is formed in the front face of the finger;
the abutment is formed in the front face of the finger; and further comprising
a beveled surface formed in the upper end of the finger to initially receive the protrusion to deflect the finger relative to the rim cover in preparation for presentation of the protrusion relative to the indentation.

3. The hanger assembly of claim 1, in which the rim cover includes an upper edge receivable in juxtaposition with the ceiling.

4. The hanger assembly of claim 1, in which the rim cover includes an in turned lower edge receivable in juxtaposition with the canopy.

5. The hanger assembly of claim 1, further comprising spacers formed between the canopy and the rim cover to interact between the canopy and the rim cover to set the rim cover at a substantially fixed circumferential spacing relative to the canopy.

6. The hanger assembly of claim 5, wherein the spacers are formed in the rim cover.

7. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and having an upper rim;
a continuous groove formed in the upper rim of the canopy;
mounting screws each extending through the rim of the canopy and engaged to the hanger bracket and having a head residing external of the rim of the canopy in the continuous groove;
a rim cover for encapsulating the heads of the screws in the continuous groove and securable with respect to the rim of the canopy;
a finger having a lower end affixed to the rim cover and an opposing upper end, a front face and an opposing rear face;
a gap between the rear face of the finger and the rim cover;
the finger flexurally resilient in reciprocal directions relative to the rim cover; and
a protrusion carried by the front face of the finger matingly receivable with the continuous groove to detachably engage the rim cover to the canopy.

8. The hanger assembly of claim 7, further comprising a beveled surface formed in the upper end of the finger to initially receive an abutment formed in the canopy to deflect the finger relative to the rim cover in preparation for presentation of the protrusion relative to the continuous groove.

9. The hanger assembly of claim 7, in which the rim cover includes an upper edge receivable in juxtaposition with the ceiling.

10. The hanger assembly of claim 7, in which the rim cover includes an in turned lower edge receivable in juxtaposition with the canopy.

11. The hanger assembly of claim 7, further comprising spacers formed between the canopy and the rim cover to interact between the canopy and the rim cover to set the rim cover at a substantially fixed circumferential spacing relative to the canopy.

12. The hanger assembly of claim 11, wherein the spacers are formed in the rim cover.

13. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and having an upper rim;
mounting screws each extending through the rim of the canopy and engaged to the hanger bracket and having a head residing external of the rim of the canopy;
a rim cover for encapsulating the heads of the screws in the continuous groove and securable with respect to the rim of the canopy;
a finger having a lower end affixed to the rim cover and an opposing upper end, a front face and an opposing rear face;
a gap between the rear face of the finger and the rim cover;
the finger flexurally resilient in reciprocal directions relative to the rim cover;
a first element of an engagement pair is carried by the rim of the canopy;
a second element of the engagement pair is carried by the front face of the finger for detachable engagement with the element of the engagement pair;
one of the first and second elements includes a circumferentially elongate slot;
the other of the first and second elements includes a protrusion receivable into and through the slot to detachably engage the rim cover to the canopy.

14. The hanger assembly of claim 13, further comprising:
the elongate slot is formed through the rim of the canopy;
the protrusion is carried by the front face of the finger; and further comprising
a beveled surface formed in the upper end of the finger to initially an abutment formed in the canopy to deflect the finger relative to the rim cover in preparation for presentation of the protrusion relative to the slot.

15. The hanger assembly of claim 13, in which the rim cover includes an upper edge receivable in juxtaposition with the ceiling.

16. The hanger assembly of claim 13, in which the rim cover includes an in turned lower edge receivable in juxtaposition with the canopy.

17. The hanger assembly of claim 13, further comprising spacers formed between the canopy and the rim cover to interact between the canopy and the rim cover to set the rim cover at a substantially fixed circumferential spacing relative to the canopy.

18. The hanger assembly of claim 17, wherein the spacers are formed in the rim cover.

19. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and including an upper rim terminating with an upper marginal edge receivable in juxtaposition with the ceiling;
mounting screws each extending through the rim of the canopy and engaged to the hanger bracket and having a head residing external of the rim of the canopy;
a circumferentially elongate notch formed in the upper rim of the canopy, the notch extending downwardly into the upper rim of the canopy from the upper marginal edge terminating with a lower edge extending between opposed side edges formed in the canopy;
a rim cover for encapsulating the heads of the screws in the continuous groove and securable with respect to the rim of the canopy;
a finger having a lower end affixed to the rim cover and an opposing upper end, a front face and an opposing rear face;
a gap between the rear face of the finger and the rim cover;
the finger flexurally resilient in reciprocal directions relative to the rim cover;
a protrusion carried by the front face of the finger matingly receivable in the notch formed in the canopy and detachably receivable against the lower edge of the notch between the opposed side edges to suspend the rim cover from the canopy.

20. The hanger assembly of claim 19, further comprising a beveled surface formed in the upper end of the finger to initially receive an abutment formed in the canopy to deflect the finger relative to the rim cover in preparation for presentation of the protrusion relative to the notch.

21. The hanger assembly of claim 19, in which the rim cover includes an upper edge receivable in juxtaposition with the ceiling.

22. The hanger assembly of claim 19, in which the rim cover includes an in turned lower edge receivable in juxtaposition with the canopy.

23. The hanger assembly of claim 19, further comprising spacers formed between the canopy and the rim cover to interact between the canopy and the rim cover to set the rim cover at a substantially fixed circumferential spacing relative to the canopy.

24. The hanger assembly of claim 23, wherein the spacers are formed in the rim cover.
